(19) United States
(12) Patent Application Publication
(10) Pub. No.: US 2015/0032857 A1
(43) Pub. Date: Jan. 29, 2015

(54) MIXER FOR PROVIDING MEDIA STREAMS TOWARDS A PLURALITY OF ENDPOINTS WHEREBY THE MEDIA STREAMS ORIGINATING FROM ONE OR MORE MEDIA SOURCE AND METHOD THEREFORE

(71) Applicants: Laurits Hamm, Aachen (DE); Bo Burman, Upplands Vasby (SE); Frank Hartung, Herzogenrath (DE); Markus Kampmann, Adernach (DE); Magnus Westerlund, Kista (SE)

(72) Inventors: Laurits Hamm, Aachen (DE); Bo Burman, Upplands Vasby (SE); Frank Hartung, Herzogenrath (DE); Markus Kampmann, Adernach (DE); Magnus Westerlund, Kista (SE)

(73) Assignee: Telefonaktiebolaget L M Ericsson (PUBL), Stockholm (SE)

(21) Appl. No.: 14/382,044

(22) PCT Filed: Mar. 1, 2012
(86) PCT No.: PCT/EP2012/053555

§ 371 Date: Aug. 29, 2014

(51) Int. Cl. H04L 29/06; H04N 7/15

(52) U.S. Cl. CPC H04L 65/4076; H04L 65/608; H04L 65/403; H04N 7/15
USPC 709/219

(57) ABSTRACT

A Mixer and a Method for providing media streams towards a plurality of endpoints, the media streams originating from one or more media source(s). Within the method at least a first request set of a first endpoint of said plurality of endpoints and a second request set of a second endpoint of said plurality of endpoints are received, whereby a request set comprises information relating to at least a subset of one or more codec parameters, and whereby a request set pertains to a media stream, whereby said first request set and said second request set pertain to a same media content. The received first request set and second request set are aggregated into an aggregated request set pertaining to a first media source. Thereafter one or more media stream(s) according to said aggregated request set are requested from said first media source.

### BACKGROUND

Media streaming is used in different scenarios. A first exemplary scenario is a live video or live audio service, which may be unicast or multicast. Another exemplary scenario is conversational video, e.g. real time video conferencing or video telephony, or conversational audio, e.g. real time audio conferencing or telephony.

I.e. streaming may be used both for uni-directional services in a broadcast or on-demand manner, while it may also be used in bidirectional services such as video or phone calls. Hence, in the following we will refer to streaming services in general even though some examples may be described with reference to a particular type of service only although in a non-limiting manner.

Today there exists an ever growing number of different end-user devices having different capabilities, e.g. in processing power, capture and render device fidelities (such as image resolution), codecs, or available network and/or available network bandwidth and/or loss network loss characteristics.

As a consequence, media session may be established involving devices having different capabilities and having different network characteristics.

For example, within videoconferencing and tele-presence services, many end-user devices and endpoints as well as a plurality of media streams may be present within the same media session. Within such multi-party scenarios it may be envisaged to use a media mixer for stream switching, mixing and transcoding, e.g. a Topo-Mixer according to IETF RFC 5117 as a central network node. These media mixers need to provide transcoding functionality in order to provide a best possible quality of a media stream towards each receiver with media streams of adapted quality.

However, transcoding comprises the drawback that processing power as well as a certain amount of memory is required and typically transcoding also negatively impact overall media quality. In addition as the process of transcoding requires a certain amount of time, transcoding introduces additional end-to-end delay, which is typically perceived as negative by the end-users.

Media streaming services are based on a Real Time Protocol, such as the IETF real-time transport protocol (RTP). Typically these Real Time Protocols comprise a real-time transport control protocol (RTCP). Furthermore, these streaming services make use of a session set up protocol such as e.g. SIP in combination with capability negotiation signaling such as e.g. SDP. This capability negotiation allows for establishing the session within some capability restrictions and limits for the session. On the other hand also a certain codec configuration may be negotiate being represented by a set of codec parameters, whereby the set of codec parameters do not pertain to a specific limit, but are a mere expression of a certain codec configuration, whereby the codec configuration itself is selected from a plurality of possible codec configurations within established limits.

At session setup, the parties, i.e. a sender of a media stream, which may also be referred as encoder, and a receiver of said media stream, which may also be referred as decoder, typically do not have a detailed knowledge about the complete session environment, e.g. whether the session will be entirely point-to-point or may contain some multi-party scenario may vary during the session.

Not only these variations pertaining to the session environment but also other reasons pertaining to the underlying networks and/or devices may necessitate a re-negotiation as will be highlighted in the following.

There can be several reasons to adapt the media rate or other properties, e.g. encoding or packetization, during an ongoing session.

E.g. in a video communication application, including WebRTC based video communication applications, the window where the media sender's media stream is presented may change, for example due to the user modifying the size of the window. It might also be due to other application related actions, like selecting to show a collaborative work space and thus reducing the area used to show the remote video in. In both of these cases it is the receiver side that knows how big the actual screen area is and what the most suitable resolution would be. It thus appears suitable to let the receiver request the media sender to send a media stream conforming to the displayed video size.

If the receiver discovers a network bandwidth limitation, it can choose to meet it by requesting media stream bit-rate limitations. Especially in cases where a media sender provides multiple media streams, the relative distribution of available bit-rate could help the application provide the most suitable experience in a constrained situation.

A media receiver may become constrained in the amount of available processing resources. This may occur in the middle of a session for example due to the user selecting a power saving mode, or starting additional applications requiring resources. Then, the receiving application can select which codec parameters to constrain and how much constrained they should be to best suit the needs of the application. For example, if lower framerate is somehow a better constraint than lower resolution.

A first reason may be that the available network bandwidth varies, which is a typical issue if mobile respectively wireless networks are involved. Another reason may be that other network properties are changing, e.g. effective MTU or packet rate limitations. Still another reason may be that the quality or representation of the media rendered towards the end user changes, maybe as a direct result of an end-user manipulating its Graphical User Interface, e.g. by changing window position and/or size or by the end-user changing other properties, e.g. whether the end user will be the active speaker or non-active speaker in a conferencing environment. Suppose the end-user is an active speaker within a conferencing application. There the end-user might select on its own motion to show other content, e.g. slides, or other alternative content sources.

Another reason may be Bandwidth optimization. Bandwidth optimization is expected to be one of the major underlying reasons to change encoding properties, since it is desirable to avoid using more bandwidth than absolutely necessary, especially considering that the expectation for high media quality will likely continue to increase, the bitrate required to transmit the media, despite increasingly efficient media coding, can also be expected to increase, the media codec configuration, the set of values for available media codec properties, suitable for a certain media bitrate typically does not scale linearly when the media bitrate changes, every media receiver may have its own preferences how the codec property values should be set for a certain media bitrate (for example, but not limited to, users with special needs), the communication scenarios will not be limited to point-to-point, potentially involving multiple and at least partly conflicting constraints from different receivers, and bandwidth is commonly and will likely continue to be a (relatively) scarce resource.

However, these variations may occur rather frequent, thereby necessitating frequent re-negotiations. On the other hand, such variations typically require that the reaction time is rather short, while renegotiation is known to afford some time. Both issues lead themselves to a rather inefficient scheme. It will be even more burdensome and inefficient if both issues are occurring at the same point in time.

However, there are further problems being based in the protocols and their usage in connection with codecs. Within the above mentioned real-time transport control protocol, messages are sent from encoder towards decoder or vice versa. An aspect of these messages pertains to information having respect to reception quality feedback, such as a last received packet, a determined loss rate, and a determined jitter.

IETF specification RFC 3550 provides for a restricted regime of providing such real-time transport control protocol messages. The restrictions pertain to the frequency of sending such messages as well as the bandwidth allowed for usage. Furthermore, the information itself which may be provided along these messages is restricted as well.

To overcome some of these restrictions an extended RTP Profile for Real-time Transport Control Protocol (IETF specification RFC 4585) has been proposed to extend the RTCP signaling mechanism.

A first extension pertains to new parameters allowing to provide further information, such as indication of loss of specific pictures or picture parts (Picture Loss Indication (PLI), Slice Loss Indication (SLI)), or information about reference pictures (Reference Picture Selection Indication (RPSI)).

Another extension pertains to relaxed constraints with respect to bandwidth and time restrictions, respectively frequency, on RTCP signaling.

An even more elaborated approach is available via another specification known as Codec Control Messages in the RTP Audio-Visual Profile with Feedback RFC 5104, which is arranged to supplement RFC 4585 (AVPF) and provides for a couple of further messages as well as for further information that can be provided using the AVPF mechanism.

The further information pertains inter alia towards parameter that relate to the control of video and media encoding. In other words, the parameter request properties of the encoding. E.g. further information may comprise a Temporary Maximum Media Stream Bit Rate Request (TMMBR), and/or a Temporary Maximum Media Stream Bit Rate Notification (TMMBN), and/or a Full Intra Request (FIR), and/or Temporal-Spatial Trade-off Request (TSTR), and/or a Temporal-Spatial Trade-off Notification (TSTN), and/or a H.271 Video Back Channel Message (VBCM).

Even though these messages may be useful for requesting encoding properties from the encoder, e.g. for rate adaptation of the encoding in case of congestion TMMBR may be used in order to decrease the media bit rate temporally, these extensions still do not allow for an efficient usage of codecs within a session environment as the possibilities to control encoding is rather limited as it only offers a limited amount of available parameters to control and as the parameters may be inter-related. Furthermore, these extensions still do not solve the problems encountered with frequent variations of a session environment respectively underlying networks or devices.

As can be seen from the aforementioned, many of the underlying reasons necessitating a media receiver to request certain codec encoding properties are highly dynamic in nature. However, using SIP/SDP to re-negotiate the session will in many cases be too slow to match the dynamic behavior. Another aspect of SIP/SDP re-negotiation is that not only the directly concerned media receivers are impacted by the re-negotiation but typically the entire set of media receivers is impacted. Furthermore, in multi-party environments transcoding introduces additional problems.

### SUMMARY

It is object to obviate at least some of the above disadvantages and to provide a mixer and methods therefore allowing for providing media streams towards different endpoints in an efficient manner.

The invention therefore proposes a method for providing media streams towards a plurality of endpoints, the media streams originating from one or more media source. In the beginning at least a first request set of a first endpoint of said plurality of endpoints and a second request set of a second endpoint of said plurality of endpoints are received, whereby a request set comprises information relating to at least a subset of one or more codec parameters, and whereby a request set pertains to a media stream, whereby said first request set and said second request set pertain to a same media content. Thereafter, said received first request set and said received second request set are aggregated into an aggregated request set pertaining to a first media source. Then a media stream according to said aggregated request set is requested from said first media source. After receiving said requested media stream from said first media source a first media stream is delivered towards said first endpoint according to the first request set and a second media stream is delivered towards said second endpoint according to the second request set.

The invention also proposes a corresponding mixer allowing for performing said method.

### BRIEF DESCRIPTION OF THE DRAWINGS

In the following the invention will be further detailed with respect to the figures.

FIG. 1 is a block diagram illustrating embodiments of an exemplary set-up,

FIG. 2 is a block diagram illustrating embodiments of a network node,

FIG. 3 is a signaling diagram illustrating embodiments pertaining to an exemplary environment,

FIG. 4 is a signaling diagram illustrating embodiments to an exemplary environment,

FIG. 5 is a flowchart illustrating embodiments of method steps, and

FIG. 6 is a flowchart illustrating details of method steps.

### DETAILED DESCRIPTION

Before embodiments of the invention are described in detail, it is to be understood that this invention is not limited to the particular component parts of the devices described or steps of the methods described as such devices and methods may vary. It is also to be understood that the terminology used herein is for purpose of describing particular embodiments only, and is not intended to be limiting. It must be noted that, as used in the specification and in the appended claims, the singular forms “a”, “an” and “the” include singular and/or plural referents unless the context clearly indicates otherwise.

Many media services allow for using codecs that may be configured in a number of different ways. Video-telephony, videoconferencing and tele-presence are some examples. Often, the codecs offer a plurality of properties that may be configured and some of these properties may also be inter-related, often in complex ways.

An example is the H.264 (AVC) video codec and derivate thereof such as the so called scalable (SVC) and multi-view (MVC) versions, but most other video codecs also have multiple configurable properties, just like many other codecs for other types of media.

In video encoding, scalable codecs like SVC (Scalable Video Coding) are gaining popularity. SVC offers a concept of encoding layers, i.e. a video stream is encoded in different layers called base layer and enhancement layers. The base layer is decodable by itself and offers a basic quality of a video stream. Decoding the base layer plus one or more enhancement layers may result in a higher-quality version of the video stream.

SVC as known today offers for example different kinds of scalability. These scalabilities pertain to:
Spatial scalability: an enhancement layer may provide for a higher spatial resolution than another (e.g. a lower) enhancement layer or the base layer. This can for example be used to encode in a lower resolution such as Standard Definition SD as a base layer and to encode a High Definition HD as an enhancement layer version of the same video stream.
Temporal scalability: an enhancement layer provides a higher temporal resolution than the lower base or enhancement layer. This can for example be used to encode a base layer with 15 fps and an enhancement layer with 30 fps. Typically, the more frames per second are encoded the result is a more smooth and less jerky impression especially in the case of strong movements in a video stream.
SNR scalability (quality scalability): temporal and spatial resolutions stay the same, but the quality increases. A higher SNR improves the details of the video, i.e. smaller and finer details are shown.

The different scalability types can be combined for a video stream. Note, not only SVC is providing the mentioned different scalability types, but also H.264/AVC supports temporal scalability using non-reference frames in the encoding, e.g. non-reference frames may be dropped to reduce the framerate of a video stream.

Also for audio codecs, scalability could be achieved as well. For audio, different scalability types may inter alia pertain to quality scalability, mono-stereo scalability or frequency range scalability (sampling rate).

Depending on the actual situation a certain scalability type offers superior performance compared to others.

For example, if the decoder is not powerful enough to decode a video at full temporal resolution, e.g. due to a lack of buffer or memory in general, an adaption of the temporal resolution, i.e. a reduction of the temporal resolution, may be useful.

On the other hand, if a decoder is gaining power, e.g. through higher priority and/or additionally assigned memory or the like, it may be useful from a user's perspective to increase temporal resolution, i.e. to request an adaption.

In case a device is switching from a high bandwidth access system towards a one offering a lower bandwidth a SNR adaption, i.e. a reduction, may be useful.

On the other hand, if a device is switching from a low bandwidth access system towards a one offering a higher bandwidth, it may be useful from a user's perspective to increase SNR, i.e. to request an adaption.

If a device at a video conference endpoint is changing, e.g. from a laptop to a mobile phone an adaption of the spatial resolution, i.e. a reduction, may be useful. On the other hand, a device at a video conference endpoint is changing, e.g. from a mobile phone to a laptop, it may be useful from a users perspective to increase spatial resolution, i.e. to request an adaption.

However, none of the protocols allows for such adaption, in particular for requesting scalable properties from an encoder such as a source, respectively an intermediate node like a mixer or proxy.

The inventors noticed that by a proper set-up and/or a messaging scheme the problems of the prior art may be overcome.

The terminology used in the following in particular may be understood as follows but is not limited to this understanding:

Bandwidth: A network resource needed to transport a certain bitrate, typically measured in bits per second. If the (media) data bitrate is less than the available bandwidth, there will be spare network bandwidth. If the sender's (media) data bitrate is more than the available bandwidth, this will lead to a need to buffer data. Depending on network type, bandwidth can either be constant or vary dynamically over time.

Bitrate: An amount of (media) data transported per time unit, typically measured in bits per second. Depending on (media) data source, bitrate can either be constant or vary dynamically over time.

Codec Configuration Parameter: An amount of (configurable value describing a certain codec property, which may impact user-perceived media) data transported per time fidelity, encoded media stream characteristics, or both. The parameter has a type (Codec Parameter Type, see below) and a value, where the type describes what kind of codec property that is controlled, and the value describes the property setting as well as how the value may be used in comparison operations.

Codec Operation Point: Also denoted just Operation Point. A set of Codec Configuration Parameter values describing one or more layers of encoding.

Codec Parameter Type: The specific type of a Codec Configuration Parameter. Each parameter type defines what unit, e.g. measured in bits per second. Depending on (media) data source, bitrate the value has. Some parameter types may be constant or may vary dynamically over time.

Encoding: A particular encoding is the resulting media stream from applying a certain choice of the media encoder (codec) respectively Codec Configuration Parameters that pertain to the encoding of the media. The media stream will offer certain fidelity (quality) of that encoding through the choice of sampling, bit-rate and/or other configuration parameters.

Endpoint: A host or node that may have a presence in an RTP session with one or more Synchronization Sources (SSRC)s.

Different encodings: An encoding is different when one or more parameter that characterizes an encoding of a particular media source is different, e.g. due to a change. Such a change may be anyone of the parameter, e.g. one or more of the following parameters; codec, codec configuration, bit-rate, sampling.

Mixer: A node which may allow for an RTP like session that generates one or more media stream(s) based on incoming media streams from one or more sources. This node is often understood as a centralized node.

RTP Session: An association among a set of participants communicating with RTP. Each RTP session may maintain a full, separate space of SSRC identifiers. It may be envisaged that each participant in an RTP session may see SSRC identifiers from the other participants, e.g. by RTP, or by RTCP, or both.

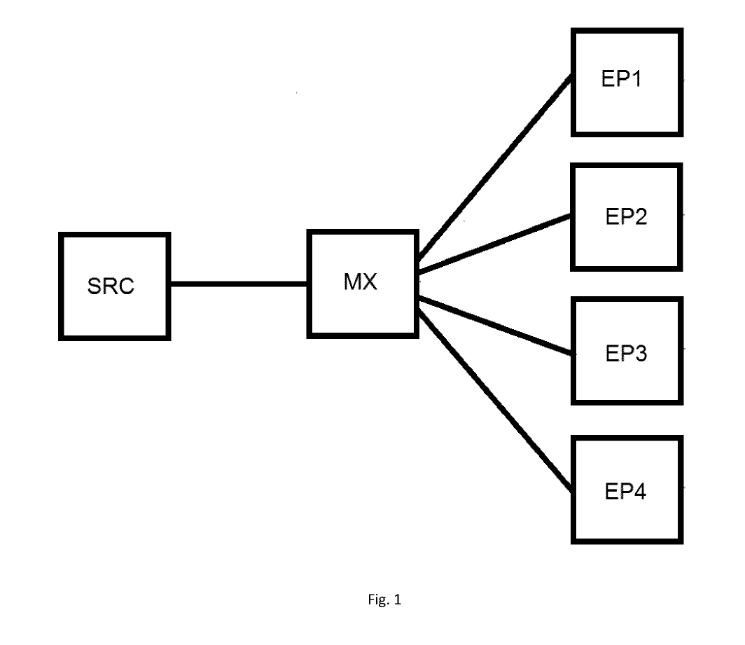

An exemplary set-up which will be used for describing the inventions and several embodiments thereof is shown in FIG. 1.

There a plurality of Endpoints EP1, EP2, EP3, EP4 are shown. These endpoints may represent media decoders. Suppose that EP1 and EP2 are requesting a certain media stream which is originating from a media source SRC via a Mixer MX. The requests pertain to the same content but provide for different set of parameters.

To enable such operation, an endpoint according to the invention may signal one or more information relating to at least a subset of one or more codec parameters. Suppose the information is relating to preferences, e.g. in terms of one or more parameter of the codec. These parameters may for a certain codec be arranged in a tuple. At least some of the parameters may not be set to a particular value but may allow the respective encoder or mixer to select an appropriate parameter. These unset parameters are sometimes also referred to as wildcarded parameter, i.e. in an actual protocol either the value is not provided or a certain parameter is set indicating that the parameter may be chosen appropriately. In the following we will assume that a non set parameter is wildcarded by the symbol “*”. I.e. the parameters for a certain codec may be the tuple ({bitrate, framerate, resolution}. Then a complete set of parameters may be e.g. {1500 kbps, 30 fps, 720p}). On the other hand, some devices may support any framerate and resolution defined for a certain parameter but may be limited to a maximum bitrate, e.g. {1500 kbps, *, *}. Note, a single parameter may nevertheless implicitly provide a certain restriction to other parameters or combination thereof.

Such a preference request is called a Codec Operation Point Request (COPR). If only one COPR is conveyed to an encoder, it does not need to use scalability, it could just encode a single layer using the signaled parameter settings. If however multiple COPRs are signaled to an encoder, it may attempt to encode the media stream in a scalable way such that the different layers thereof, e.g. video layers, match the signaled COPR operation points.

The mechanism described in this document also allows for heterogeneous multi-party scenarios where different endpoints require differently encoded media from a source, but its use in other situations is not precluded.

In a described scenario the media stream from an encoder is sent to multiple decoders, and hence the encoder may provide an encoding with multiple operation points, suitable for the receivers.

The proposed idea may also be used during an active session to quickly adapt to changes in receiver available bandwidth and/or preferences for one or more codec properties, while still conforming to the SDP negotiated minimum or maximum limits (depending on individual SDP property semantics), i.e. also changes that pertain to an SDP negotiated set and thus do not impact the SDP may be handled.

In the following an entity MX is described that aggregates COPR (Codec Operation Point Requests) which may also be embodied in a VOPRs (Video Operation Point Requests, its logic and some exemplary COPR aggregation rules. Irrespective of the following description, a Codec Operation Point as well as the messages involved may pertain to Audio Operation Points as well as Video Operation Points as examples thereof while not being limited thereto. Hence, the invention may also be directed to AOPRs (Audio Operation Point Requests), or even more general towards Codec Operation Point Requests (COPRs) supporting e.g. codecs for audio, video or other media types like 3D video.

This entity MX may be part of a proxy or of an encoder.

In the following such an entity MX (media mixer) that received multiple COPRs (wildcarded or not), and consolidates them, e.g. into a aggregated list, will be described. This aggregated list may be forwarded, e.g. from mixer MX to encoder SRC, or used in the entity itself. The encoder SRC receives a consolidated list to encode the requested media accordingly, e.g. multiple operation points, which preferably are close to the operation points in the aggregated COPR (COPRA), but don't have to match them perfectly. The encoder SRC then transmits the media towards the entity MX.

The entity MX further uses the aggregated list it has generated to derive media stream forwarding and processing decisions. It may drop certain data, e.g. video enhancement layer information for receivers that have requested a lower-quality version. If such a version is not available as part of the media stream, the entity MX may also decide to produce it by transcoding.

In an embodiment, an entity MX that aggregates COPRs, converts the aggregated COPR set into a certain setting of the scalable encoder e.g. selection of a layer structure may discard parts of the scalable video bitstream in order to deliver video streams to individual receivers that consider the respective individual COPR restrictions is described.

### Aggregation of COPRs

The node MX receives COPRs from receivers EP1, EP2, . . . . Each receiver EP1, EP2, may send one or more COPRs. For ease of understanding in the following we will only assume that a single COPR is sent, i.e. one operation point. The COPRs are not synchronized and thus COPRs from different receivers EP1, EP2 may arrive at different times. Some receivers may send new or updated COPRs more frequently, while others may only send one at the start of a session, and may not change them later.

A COPR may contain a parameter tuple {bitrate, framerate, resolution}. Some of the parameters may be wildcarded. Resolution may comprise an x- and an y-resolution. However, one may also foresee that by a particular x- or y-Resolution, the respective other value may be implicitly given, e.g. if a y-Resolution is 1200 than x-Resolution is 1920. Thus, a COPR parameters may be understood to span a 4-dimensional space (bitrate, framerate, x-resolution, y-resolution).

Now, Duplicates, i.e. parameter sets originating from different endpoints EP1, EP2, . . . but relating to the same media and having same characteristics within the parameter space may be removed. I.e. Endpoints requesting the same media with the same characteristics are consolidated into a single request. In this case one may understand the mixer MX as a proxy. Thereby the overall network load towards the media source SRC is reduced.

For COPR pairs where a non-wildcarded COPR matches a wildcarded COPR, the respective wildcarded COPR is removed. For example, if there is a first COPR1 {1500 kbps, *, 1280×720} of endpoint EP1 and a second COPR2 {1500 kbps, 15 fps, 1280×720} of endpoint EP2, the less specific one {1500 kbps, *, 1280×720} may be removed, as it is included in the more specific one, but not vice versa. I.e. Endpoints requesting the same media where the characteristics are comprised by way of wildcards are consolidated into a single request. Note, that some codec parameters are not orthogonal, which may lead to a “conflict” situation where the type of parameters sent in COPR from different endpoint EP1 and EP2 restrict each other's value range by inter-relation. For example COPR1 of endpoint EP1 is requiring a certain amount of forward error correction, which in turn means that the amount of data that has to be sent is increasing while COPR2 of endpoint EP2 limits the bitrate. Those parameters may thereof be in conflict and a “reasonable” tradeoff may be foreseen.

Thereby the overall network load towards the media source SRC is reduced as there will be only a single request COPRA send by the Mixer towards the media source SRC and only a certain encoding is necessary by the media source SRC. Consequently the media stream may be distributed by the Mixer MX towards the endpoints EP1 and EP2.

A further reduction of the number of COPRs may be performed as follows:

For each receiver EP1, EP2, . . . at least one COPR preferably remains in order that it may still receive a media stream according its request, e.g. does not exceed its highest requested COPR.

If COPRs are (very) close to each other one may be discarded. Alternatively, they may be aggregated by producing a “least common denominator”, e.g. a first COPR1 {1450 kbps, 30 fps, 1280×720} of endpoint EP1 and a second COPR2 {1500 kbps, 28 fps, 1400×900} of endpoint EP2 may be consolidated into {1450 kbps, 28 fps, 1280×720}. Note, that some codec parameters are not orthogonal, which may lead to a “conflict” situation where the type of parameters sent in COPR from different endpoint EP1 and EP2 restrict each other's value range by inter-relation. For example COPR1 of endpoint EP1 is requiring a certain amount of forward error correction, which in turn means that the amount of data that has to be sent is increasing while COPR2 of endpoint EP2 limits the bitrate. Those parameters may thereof be in conflict and a “reasonable” tradeoff may be foreseen. This represents a change in paradigm as it allows a mixer MX to deviate from the exactly defined requests COPR1 and COPR2. In this case it may be foreseen that the Mixer MX will inform the respective endpoints EP1 and EP2 of the change.

However, COPRs that are not close to each other may remain unchanged in the aggregated COPR list, as for each receiver EP1, EP2, . . . at least one COPR preferably remains in order that it may still receive a media stream according its request, e.g. does not exceed its highest requested COPR.

At the encoder SRC an analysis of the aggregated COPR set may be carried out. It is then decided which scalability types (spatial, temporal, SNR) are supported and e.g. how many layers for each type are needed. In addition, the parameters for each layer i.e. temporal/spatial resolution and bit rate may be determined. In order to reduce complexity of the encoding process and corresponding to the encoder capabilities and capacity, a further simplification of the aggregated COPR set may be executed which is similar to the process performed by the mixer during aggregation. Note, even thought the SRC is described here as a true media source, it may also be that a Mixer MX is sending its aggregated request COPRA towards another Mixer which than performs the same logic.

The encoded (scalable) bit stream may be sent towards the mixer MX. The information about the (scalable) structure may be included in-band in the scalable media stream.

The mixer MX having knowledge of the available layers respectively scalability also knows the requested COPR (COPR1, COPR2) or COPRs for each receiver. The mixer MX may now send respective portions of the media stream to the receiver EP1, EP2, . . . that is as close as possible to the (“highest”) requested COPR, preferably it is not exceeding the requested COPR. In case the request did not detail a certain property, e.g. it is wildcarded, the mixer MX may choose among the ones which may be provided. Here, the choice may be such that the amount of additional processing is minimized.

In a first embodiment several messages are proposed, comprising a Codec Operation Point request, a Codec Operation Point Acknowledgment and a Codec Operation Point Notification message.

These messages may be seen as particular embodiments of a general feedback message COP, for codec control of real-time media which is proposed. Such a feedback message may be used as an extension to the AVPF, e.g. as defined in RFC 4585, respectively CCM, e.g. as defined in RFC5104, specifications.

The AVPF specification outlines a mechanism for fast feedback messages over RTCP, which is applicable for IP based real-time media transport and communication services. It defines both transport layer and payload-specific feedback messages. This invention in particular targets the payload-specific type, since a certain codec is typically described by a payload type.

AVPF defines and CCM define different payload-specific feedback messages (PSFB). These feedback messages may be identified by means of a feedback message type (FMT) parameter.

To stay within this scheme a further payload-specific feedback message is proposed by providing another feedback message type (FMT) parameter allowing for identifying these proposed payload-specific feedback messages. E.g. a proposed PSFB FMT value exemplarily chosen may be Codec Operation Point (COP).

The “SSRC of packet sender” field within the common packet header for feedback messages (e.g. as defined in section 6.1 of RFC 4585), may indicate the message source. Since the invention may not use the “SSRC of media source” in the common packet header is will typically be set to 0.

### Feedback Control Information (FCI) Format

An exemplary COP FCI format is outlined below:

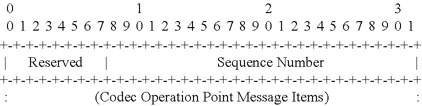

Exemplary FCI fields are:
Reserved: may be set to 0 by senders and may be ignored by receivers implementing this solution.
Sequence Number: This is scoped by “SSRC of packet sender”. The Sequence Number may be increased by 1 modulo 2̂24 for each new COP message. A repeated message may not increase the Sequence Number. The initial value may be chosen randomly. When a COP FCI is received with same Sequence Number as was previously received, it may be interpreted as a repeated message and may be ignored.

The FCI may contain one or more Codec Operation Point Message Items. The number of COP Message Items in a COP message may be limited, e.g. by the Common Packet Format ‘length’ field.

### COP Message Item Format

Codec Operation Point Message Items may share a common header format:

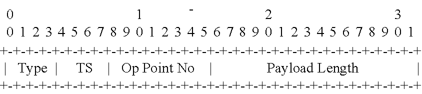

Exemplary message header fields are:
Type (e.g. 4 bits): Message Item Type. In the following three item types are described, namely COPA, COPR and COPN, however, the invention is not limited thereto. These Message Item Types may show the following exemplary correspondence:

| Value | Message Item Type |
|---|---|
| 0 | Codec Operation Point Acknowledge (COPA) |
| 1 | Codec Operation Point Request (COPR) |
| 2 | Codec Operation Point Notification (COPN) |

TS (e.g. 4 bits): Type Specific value. The semantic is typically message specific, i.e. depending on the particular Message Item Type. May be set to 0 for message items not using the field.
Op Point No (e.g. 8 bits): Operation Point Number. Some codecs, e.g. scalable codecs, are capable of encoding into multiple simultaneous operation points using the same SSRC, and each operation point can be referenced by Op Point No.
Payload Length (e.g. 16 bits): The total length in bytes of all Message Payload data belonging to this message, following the header. The length MAY be 0.

For a smooth operation it may be envisaged that if a COP Message Items with a higher Sequence Number (also taking wraparound into account) is received, it may override Message Items of the same Item Type, targeted to the same SSRC and Op Point No. having a lower Sequence number

### Codec Operation Point Acknowledge

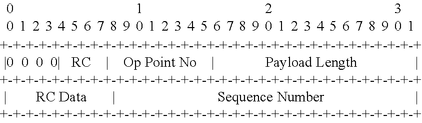

Exemplary COPA-specific message fields are:
RC Return Code. Exemplary Return Codes may be as follows:

| Value | Meaning | RC Data |
|---|---|---|
| 0 | Success | |
| 1 | Rejected; Too many operation points | Max # op points |

Op Point No: This field is typically not used and may therefore be set to 0.
RC Data may contain supplementary information concerning the Return Code RC. This field is typically not used and may therefore be set to 0.

The COPA Message Item acknowledges reception of a COP message containing at least one COPR Message Item targeted at the acknowledging SSRC. COPA may announce success or failure by the media sender with respect to a COPR. COPA does not guarantee that any of the Codec Parameter Values in the COPR are accepted, but only that a COPR was successfully received. The chosen Codec Parameter Values resulting from the received COPR, possibly taking other COPR messages and other aspects into account, are typically provided within one or more COPN messages related to the COPR. E.g. the COPN may be contained in the same COP Message as the COPA.

For a smooth operation it may be envisaged that if a COPR receiver has received a COP Message Item with a higher Sequence Number (also taking wraparound into account) is received, it may override Message Items having a lower Sequence number

Receiving a COPR may trigger sending a COPA at the earliest opportunity. However, there might be envisaged exceptions, e.g. a media sender that receives a COPR with a previously received Sequence Number closely after sending a COPA for that same Sequence Number (e.g. within 2 times the longest observed round trip time, plus any AVPF-induced packet sending delays), could await a new or repeated COPR before scheduling another COPA transmission, to avoid sending unnecessarily.

A mixer or media translator that implements this invention, which is encoding content sent towards one or more media receivers and that itself receives COPR may also respond with COPA, just like any other media sender. A mixer or media translator which is unable to fulfill a COPR and therefore forwarding it unaltered towards the media sender, may also forward the corresponding COPA in the backward direction.

### Codec Operation Point Request

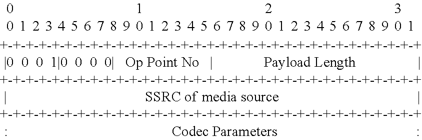

Exemplary Codec Parameters may comprise zero or more TLV (Type-Length-Value) carrying one or more Codec parameters as described below with respect to Parameter Types.

A Codec Operation Point Request may be sent by a media receiver wanting to control one or more Codec Parameters of a media sender, within the media capability negotiated. The available codec parameters that can be controlled are further detailed below.

A single COPR may comprise multiple Codec Parameters, in which case they jointly and simultaneously may represent a requested Operation Point. An Operation Point may then be identified by the Operation Point ID (OPID), e.g. by a tuplet <SSRC of media source, Op Point No> allowing for unique attribution.

A media sender receiving a COPR may take the request into account also for future encoding, but a media sender may also take COPR from other media receivers into account when deciding how to change encoder parameters. A requesting media receiver thus cannot always expect that all Parameter Values of the request are fully honored. To what extent a request with respect to its parameter is honored may be provided by means of one or more COPN messages, constituting a verbose acknowledgement.

As already stated a COPR with a more recent Sequence Number is held to replace a previous COPR with the same OPID. Any previous restrictions may be removed for Codec Parameters not present in an updated COPR. E.g. a COPR showing an Operation Point without any Codec Parameters is releasing all previous restrictions on the Operation Point, which may also be understood as that the Operation Point is no longer needed by the media receiver.

The timing may follow the rules outlined in section 3 of RFC 4585. As a request message may be time critical, it may be sent as soon as possible, e.g. it may be sent using early or immediate feedback RTCP timing. If it is known (e.g. by the application) that a quick feedback is not required, it may be envisaged to sent the message with regular RTCP timing.

It may be envisaged that a COPR sender that did not receive a corresponding COPA for certain times the longest observed round trip time (e.g. 2 times) may choose to re-transmit the COPR, without increasing the Sequence Number.

A mixer or media translator that implements the invention and encodes content sent to the media receiver issuing the COPR may consider the request to determine if it can fulfill it by changing its own encoding parameters. A media translator unable to fulfill the request may forward the request unaltered towards the media sender. A mixer encoding for multiple session participants will need to consider the joint needs of these participants before generating a COPR on its own behalf towards the media sender.

### Codec Operation Point Notification

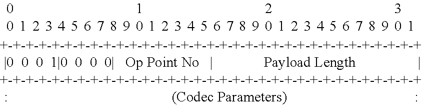

Exemplary Codec Parameters may comprise zero or more TLV (Type-Length-Value) carrying one or more Codec parameters as described below with respect to Parameter Types.

This message may be sent by a media sender as a notification of chosen Codec Parameters resulting from reception of a COPR message. All Operation Points (e.g. identified by OPID) in COPR messages positively acknowledged by a COPA may also be detailed by a corresponding COPN Operation Point, if they are accepted as Operation Points that will be used. Exemplary available codec parameters that may be controlled are detailed below.

Note an Op Point No used in the COPN has not necessarily a defined relation to the Op Point No used in a related COPR. This is because a media sender may have to take other aspects than a specific COPR into account when choosing what Operation Points and how many Operation Points to use. Typically, it is the responsibility of a COPN receiver to appropriately map Operation Points from the COPR onto the chosen Operation Points in the returned COPN. Note also that the COPN may contain more or fewer Operation Points than what was requested in the COPR.

A media sender implementing this solution may take requested Operation Points from COPR messages into account for future encoding, but may also decide to use other Codec Parameter Values than those requested, e.g. as a result of multiple (possibly contradicting) COPR messages from different media receivers, or any media sender policies, rules or limitations. The media sender may include values for all requested Codec Parameters, but may also omit Codec Parameters that cannot be restricted further from the capability negotiation. Thus, a COPN message Operation Point may use other Codec Parameters and other values than those requested.

COPA is a more formal COPR reception acknowledgement while a COPN may comprise supplemental information about the parameter choices. It is understood that COPA and COPN are only described as different messages but may also be merged into one.

A COPN message may comprise an Operation Point without any Codec Parameters, which may be understood as a rejection or (if it was previously defined) removes that Operation Point from the media stream.

If a media sender can no longer fulfill the established Codec Parameter restrictions of a signaled Operation Point, it may change any Codec Parameter or even remove the entire Operation Point. Such a change may be signaled towards a concerned media receiver at the earliest opportunity by sending an updated COPN to the media receiver. A media sender may schedule transmission of COPN at any time when there is a need to inform the media receiver(s) about what Codec Parameters will henceforth be used for an Operation Point, not only as a response to COPR.

The timing may follow the rules outlined in section 3 of RFC 4585. As a COPN notification message is typically not extremely time critical and may be sent using regular RTCP timing. In case of a change, it may nevertheless be envisaged to be sent as soon as possible, e.g. it may be sent using early or immediate feedback RTCP timing.

Furthermore, any actual changes in codec encoding corresponding to COPN Codec Parameters may be executed only after a certain delay from the sending of the COPN message that notifies the world about the changes. Such a delay may be specified as at least twice the longest RTT as known by the media sender, plus a media sender's calculation of the required wait time for sending of a further COPR message for this session based on AVPF timing rules. Such a delay may be introduced to allow other session participants to make their respective limitations and/or requirements known, which respective limitations and/or requirements may be more strict than the ones announced in COPN.

A mixer or translator that acts upon a COPR may also send the corresponding COPN. In cases where it needs to forward a COPR itself, the COPN may need to be delayed until that COPR has been responded to.

### Parameter Types

COP Message Items may contain one or more Codec Parameters, e.g. encoded in TLV (Type-Length-Value) format, which may then be interpreted as simultaneously applicable to the defined Operation Point. Typically, the values are byte-aligned.

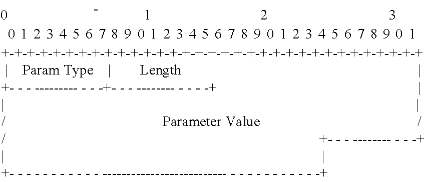

Param Type (e.g. 8 bits): The Codec Parameter Type, as proposed below and possible extensions to this invention. A receiver of a parameter with an unknown Param Type may ignore it.
Length (e.g. 8 bits): The Parameter Value Length in bytes.
Parameter Value (e.g. variable length): The actual parameter value, encoded in a format proposed by the specific Param Type definition.
If multiple Codec Parameters with the same Param Type are included in the same COP Message, Codec Parameters appearing towards the end of the Codec Parameter list may override Codec Parameters that appeared earlier in the list, unless other semantics are explicitly proposed for that Codec Parameter.
A Codec Parameter that is encoded in a way (including incorrectly) that cannot be interpreted by the receiver may be ignored.

### Parameter Type Values

In the following different exemplary parameter types are described. These parameters may describe a codec property to be controlled for a certain operation point.

| Value | Meaning | Tag |
|---|---|---|
| 0 | Bitrate | bitrate |
| 1 | Token Bucket Size | token-bucket |
| 2 | Framerate | framerate |
| 3 | Horizontal Pixels | hor-size |
| 4 | Vertical Pixels | ver-size |
| 5 | Channel | channels |
| 6 | Sampling Rate | sampling |
| 7 | Maximum RTP Packet Size | max-rtp-size |
| 8 | Maximum RTP Packet Rate | max-rtp-rate |
| 9 | Frame Aggregation | aggregate |
| 10 | Redundancy Level | red-level |
| 11 | Redundancy Offset | red-offset |
| 12 | Forward Error Correction Level | fec-level |

Typically all Codec Parameter values are binary encoded, whereby the most significant byte is typically first (in case of multi-byte values).

### Bitrate

The transport level average media bitrate value (similar to b=AS from SDP) may be expressed in bits/s. Also a value of 0 may be used. This property may be held generally valid for all media types.

### Token Bucket Size

The transport level token bucket size, may be expressed in bytes. This property may be held generally valid for all media types. Note that changing a token bucket size does not change the average bitrate, it just changes the acceptable average bitrate variation over time. A value of 0 is generally not meaningful and may not be used.

### Framerate

A media frame is typically a set of semantically grouped samples, i.e. the same relation that a video image has to its individual pixels and an audio frame has to individual audio samples. A media framerate may be expressed in 100th of a Hz. A value of 0 may be used. This property is mainly intended for video and timed image media, but may be used also for other media types. Note that the value applies to encoded media framerate, not the packet rate that may be changed as a result of different Frame Aggregation.

### Horizontal Pixels

The horizontal pixels describe horizontal image size in pixels. This property may be used for video and image media.

### Vertical Pixels

The vertical pixels describes horizontal image size in pixels. This property may be used for video and image media.

### Channels

Channels may describe a number of media channels. E.g. for audio, an interpretation and spatial mapping may follow RFC 3551, unless explicitly negotiated, e.g. via SDP. For video, it may be interpreted as the number of views in multi-view coding, e.g. where a number of 2 may represent stereo (3D) coding, unless negotiated otherwise, e.g. via SDP.

Obviously, it does not make sense to use such a parameter if the concerned multi-channel coding is not supported by both ends.

### Sampling Rate

The sampling rate may describe the frequency of the media sampling clock in Hz, per channel. A sampling rate is mainly intended for audio media, but may be used for other media types. If multiple channels are used and different channels use different sampling rates, this parameter may be used unless there is a known sampling rate relationship between the channels that is negotiated using other means, in which case the sampling rate value may applies to the first channel only.

Note, typically only a limited subset of sampling frequencies makes sense to the media encoder, and sometimes it is not possible to change the sampling rate at all. For video, the sampling rate is very closely related to the image horizontal and vertical resolution, which are more explicit and which are more appropriate for the purpose. For audio, changing sampling rate may require changing codec and thus changing RTP payload type.

Note, the actual media sampling rate may not be identical to the sampling rate specified for RTP Time Stamps. E.g. almost all video codecs only use 90 000 Hz sampling clock for RTP Time Stamps. Also some recent audio codecs use an RTP Time Stamp rate that differs from the actual media sampling rate.

Note that the value is the media sample clock and may not be mixed up with the media Framerate.

### Maximum RTP Packet Size

The maximum RTP packet size is the maximum number of bytes to be included in an RTP packet, including the RTP header but excluding lower layers. This parameter MAY be used with any media type. The parameter may typically be used to adapt encoding to a known or assumed MTU limitation, and MAY be used to assist MTU path discovery in point-to-point as well as in RTP Mixer or Translator topologies.

### Maximum RTP Packet Rate

The maximum RTP Packet Rate is the maximum number of RTP packets per second. This parameter MAY be used with any media type. The parameter may typically be used to adapt encoding on a network that is packet rate rather than bitrate limited, if such property is known. This Codec Parameter may not exceed any negotiated “maxprate” RFC 3890 value, if present.

### Frame Aggregation

The frame aggregation describes how many milliseconds of non-redundant media frames representing different RTP Time Stamps that may be included in the RTP payload, called a frame aggregate. Frame aggregation is mainly intended for audio, but MAY be used also for other media. Note that some payload formats (typically video) do not allow multiple media frames (representing different sampling times) in the RTP payload.

This Codec Parameter may not be used unless the “maxprate” RFC 3890 and/or “ptime” parameters are included in the SDP. The requested frame aggregation level may not cause exceeding the negotiated “maxprate” value, if present, and may not exceed the negotiated “ptime” value, if present. The requested frame aggregation level may not be in conflict with any Maximum RTP Packet Size or Maximum RTP Packet Rate parameters.

Note that the packet rate that may result from different frame aggregation values is related to, but not the same as media Framerate.

### Redundancy Level

The redundancy level describes the fraction of redundancy to use, relative to the amount of non-redundant data. The fraction is encoded as two, binary encoded 8-bit values, one numerator and one denominator value. The fraction may be expressed with the smallest possible nominator and denominator values.

This Codec Parameter may not be used if the capability negotiation did not establish that redundancy is supported by both ends. The redundancy format to use, e.g. RFC 2198, may be negotiated via other means. What is meant by fractional redundancy levels, e.g. if one of N media frames are repeated or if partial (more important part of) media frames are repeated, may be negotiated via other means.

The redundancy level may be used with any media, but is mainly intended for audio media.

The requested redundancy level likely impacts transport level bitrate, token bucket size, and RTP packet size, and may not be in conflict with any of those parameters.

### Redundancy Offset

The redundancy offset describes the time distance between the most recent data and the redundant data, expressed in number of “frame aggregates”, encoded as a list of binary encoded 8-bit numbers, where the value 0 represents the most recent data. Note that the number of offsets impacts the redundancy level and the two parameters may be correctly aligned. Specifically, specifying a Redundancy Offset implies that Redundancy Level cannot be 0.

The redundancy offset may be used with any media, but is mainly intended for audio media.

### Forward Error Correction Level

The forward error correction level describes the fraction of FEC data to use, relative to the amount of non-redundant and non-FEC data. The fraction is encoded as two, binary encoded 8-bit values, one numerator and one denominator value. The fraction may be expressed with the smallest possible nominator and denominator values.

This Codec Parameter may not be used if the capability negotiation did not establish that FEC is supported by both ends. The FEC format to use, e.g. RFC 5109, may be negotiated via other means.

The forward error correction level MAY be used with any media.

The requested FEC level likely impacts transport level bitrate, token bucket size, and RTP packet size, and preferably are not in conflict with any of those parameters.

### SDP Extensions

As described in RFC 4585 and RFC 5104, the rtcp-fb attribute may be used to negotiate the capability to handle specific AVPF commands and indications, and specifically the “ccm” feedback value is used for codec control. All rules related to use of “rtcp-fb” and “ccm” also apply to the proposed feedback message proposed in this solution.

Extension of the rtcp-fb Attribute

In this invention, in an embodiment a proposed “ccm” parameter of rtcp-fb-ccm-param is proposed, e.g. as described in RFC5104:

A “cop” parameter may indicate support for COP Message Items and one or more of the Codec Parameters proposed in this invention.

The Augmented Backus-Naur Form (ABNF) for the proposed parameter may be described as follows:

```
rtcp-fb-ccm-param =/ SP ″cop″ 1*rtcp-fb-ccm-cop-param
rtcp-fb-ccm-cop-param = SP ″bitrate″
  / SP ″token-bucket″
  / SP ″framerate″
  / SP ″hor-size″
  / SP ″ver-size″
  / SP ″channels″
  / SP ″sampling″
  / SP ″max-rtp-size″
  / SP ″max-rtp-rate″
  / SP ″aggregate″
  / SP ″red-level″
  / SP ″red-offset″
  / SP ″fec-level″
```

Token values for the rtcp-fb-ccm-cop-param have been proposed previously in this invention. One or more supported Parameter Types may be indicated by including one or more rtcp-fb-ccm-cop-param.

Within the proposed scheme, the usage of Offer/Answer as described in RFC 3264 may inherit all applicable usage defined in RFC 5104.

In particular, a offerer may indicate the capability to support the CCM “cop” feedback message and the offerer may also indicate the capability to support receiving and acting upon selected Parameter Types. It is to be understood that parameter types that can or will be sent may be different than the ones supported to receive.

According to the invention, an answerer not supporting the proposed scheme COP may remove the “cop” CCM parameter. This is in line with RFC 5104 and provides for backward compatibility.

An answerer supporting COP may indicate the capability to support receiving and acting upon selected Parameter Types. It is to be understood that parameter types that can or will be sent may be different than the ones supported to receive.

Neither an offerer nor an answerer may send any Parameter Types that a respective remote party did not indicate support for.

The proposed mechanism is not bound to a specific codec. It uses the main characteristics of a chosen set of media types, including audio and video. To what extent this mechanism can be applied depends on which specific codec is used. In particular, it is envisaged to use the mechanism for H.264 AVC, SVC and MVC as well as for audio codec such as MPEG4 AAC.

This invention in particular pertains to the usage of multiple video operation points and therefore applies especially to scalable video coding. Scalable video coding such as H.264 SVC (Annex G) uses scalability dimensions: spatial, quality and temporal. Some non-scalable video codecs such as H.264 AVC can realize multiple operation points as well. H.264 AVC can encode a video stream using non-reference frames such that it enables temporal scalability.

Other embodiment may use other messages as will be detailed in the following.

Within another exemplary embodiment a heterogeneous multi-party scenario where different endpoints require differently encoded media from the same source is referenced. It may be noted that other scenarios are thereby not precluded. In the described scenario the media stream from an encoder SRC is sent to multiple decoders EP1, EP2, . . . and an encoder SRC may need to provide an encoding with multiple operation points, suitable for each respective receiver EP1, EP2. This may not only be achieved by use of so called scalable codecs, but some codecs offer inherent scalability features without being generally considered as scalable, e.g. H.264/AVC temporal scalability may be achieved by non-reference frames.

The solution proposed in the following may be used during an active session to quickly adapt to changes, e.g. in media receiver available bandwidth and/or preferences for one or more other codec properties, while still conforming to the SDP negotiated minimum or maximum limits (depending on individual SDP property semantics). Some needed or wanted codec property changes will also motivate to re-negotiate the SDP, but the scope of this solution intends to cover only changes that lies within the SDP negotiated set and thus do not impact the SDP.

Within this embodiment, a request, a notification, and a status report are proposed. The messages may be sent unreliably (e.g. being based on RTCP) and may be lost.

### Request:

A media receiver EP1, EP2, . . . requesting a media sender SRC, MX to adjust one or more of its media encoding parameters for a certain media stream. The request COPR is normally based on a specific set of media encoding parameters that the media sender has explicitly notified the media receiver about in a notification. The request is sent by a media receiver, which can be either an end-point or a middle node such as a media mixer. The receiver of the request may similarly be either the original media sender or a media mixer. Included in the request is a description of the desired codec configuration for one or more media streams. The parameter values communicated in a notification of that stream can be a very useful starting point when deciding what parameter values to choose for the request, but is not an absolute requirement to be able to create a meaningful request. The request can include a set of changed properties for existing streams, but it can also request the addition or removal of one or more media sub-streams having certain properties, in which case there will be no notification to base the request on.

The media sender receiving a specific request is not required to re-configure the encoder accordingly, even if it may try to do so, but is allowed to take other (previous or concurrent) requests and any local considerations into account, possibly modifying some of the parameter values, or even totally rejecting the request if it is not seen as feasible. It is thus not possible for a media receiver to uniquely see from the media stream or even from a notification if the media sender received the request or if the request was lost and needs to be re-sent.

The codec properties to include in a request may ideally be possible to limit to the ones that differ from how the stream is currently configured. To achieve that, both media sender and media receiver needs to keep codec property state for all streams.

A request may typically be based on a certain notification, but there may be situations where a request is sent approximately simultaneously with a new notification for the same stream. In that case, there is a risk that the request is based on the wrong set of codec properties compared to the new notification. It is therefore necessary to have the set of codec properties, the operation point, be version controlled. If a notification announces a specific version of the operation point, where the version is updated every time it is changed, the request can refer to that specific version and any mis-reference can be clearly identified and resolved. In addition, it allows for easy identification of repeated notifications and requests, simply by checking the operation point identification and the version, and without having to parse through all of the codec properties to see if any one changed.

The choice of what parameter values to include in a specific request is typically based on the received media stream properties, possibly in combination with a notification describing the stream in defined terms. If there is a mismatch between the codec configuration used to base the request on and the codec configuration actually used when acting on the request, the resulting configuration will likely not be what the requesting media receiver intended.

When the media stream contains sub-streams, which is typically the case for scalable coding, there exist no generally specified means to address the sub-streams, but that is typically codec specific. The length and structure of the sub-stream identifier is thus in general not known and some flexible means is required for that type of addressing. For example, a media sender using multiple sub-streams may receive a request from a media receiver to use a certain configuration. The media sender can, as was described above, decide that one of it's sub-streams is already close enough to the request or can be changed to match the request. Pointing out this sub-stream to the media receiver among a potentially large set of other sub-streams will likely be very helpful, compared to letting the media receiver evaluate all sub-streams for applicability to the request. This functionality is achieved by including one or more sub-stream references in the request acknowledgement.

### Notification:

A media sender SRC, MX notifying a media receiver EP1, EP2, . . . of the currently used media encoding parameters for a certain (identified) media stream. The notification is initiated by the media sender, typically whenever the media encoding parameters changed significantly from what was previously used. The reason for the change can either be local to the media sender (user, end-point or network), or it can be the result of one or more requests from remote end-points.

A notification may be sent by a media sender and describes a media stream or sub-stream in terms of a defined finite set of codec properties. The same set of codec properties can also be used in a request. The notification and a common set of defined properties is important to a media receiver since it is rarely possible to see from the media stream itself what controllable properties were used to generate the stream. The set of codec properties and their values used to describe a certain media stream at a certain point in time is henceforth called a codec configuration. It may be possible for a media sender to change codec configuration not only based on requests from media receivers, but also based on local limitations, considerations or user actions. This implies that also the notification may be possible to send standalone and not only as a response to a request. To avoid that media receivers have to guess what codec configuration is used, a media sender may always send notifications whenever codec configuration for a stream changes. Loss of a notification may anyway not be critical since a media receiver could either fall back to infer approximate codec configuration from the media stream itself, or wait until the next notification is sent.

A notification can potentially contain a large amount of codec properties. To limit the amount of properties that needs to be sent, only the ones significantly different from capability signaling or “default” values may have to be included in a notification. Parameters that are not enabled by codec capability signaling or inherently not part of the used codec need also not be included.

The notification is sent by a media sender and describes a media stream or sub-stream in terms of a defined, finite set of codec properties. That same set of codec properties can also be used in a request. The notification and a common set of defined properties is important to a media receiver since it is rarely possible to see from the media stream itself what controllable properties were used to generate the stream. The set of codec properties and their values used to describe a certain media stream at a certain point in time is henceforth called a codec configuration.

It may be possible for a media sender to change codec configuration not only based on requests from media receivers, but also based on local limitations, considerations or user actions. This implies that the notification may be possible to send standalone and not only as a response to a request. To avoid that media receivers have to guess what codec configuration is used, a media sender may always send notifications whenever codec configuration for a stream changes. Loss of a notification may anyway not be critical since a media receiver could either fall back to infer approximate codec configuration from the media stream itself, or simply wait with a request until the next notification is sent.

A notification can potentially contain a large amount of codec properties. However, parameters that are not enabled by codec and COP capability signaling, or inherently not part of the used codec will not be included. The notification only describes the currently used codec configuration, and each parameter in an operation point will thus be described by a single value. To further limit the amount of properties that needs to be sent, it is possible to rely on parameter defaults (listed by individual parameter type definitions) whenever those values are acceptable.

The media receiver could want to take some local action at the time when the codec configuration in the media stream changes. Using the same reasoning as above, this may not be possible to see from the media stream itself. This functionality is explicitly enabled by inclusion of an RTP Time Stamp in the notification, where the Time Stamp describes a time (possibly in the future) when the media stream codec configuration is (estimated to be) effective.

### Status Report:

A media sender reporting to a request sender (media receiver) on request reception status; which specific request from the media receiver that was received and considered in setting current media encoding parameters, and the identification of the media stream that is considered to fulfill the request. The status report can also indicate various error conditions, such as reception of invalid or failing requests.

The status report is sent by a media sender and is needed to confirm reception of a specific request OPID to avoid unnecessary retransmission of requests. Loss of a status report will likely trigger a request retransmission, except when the request sender can infer from the media stream or a notification that the stream is now acceptable.

The status report is not a required acknowledgement of every request, but instead reports on the last received request, identified by a request sequence number in addition to the OPID and Payload Type.

That de-coupling of request and status report reduces the needed amount of status reports in case of frequently updated requests and/or lack of resources to send status reports.

If a request is somehow not acceptable to a media sender, the status report can also indicate failure and a reason for that failure. In case the OPID in the request is a “provisional” OPID, the status report responds with that exact OPID, but also includes a reference to a “real” media (sub-)stream identification or OPID that the media sender considers appropriate for the request.

No description of any codec configuration is included in a status report, even if the corresponding request was successful. Used codec configuration is only carried in the notification message. Multiple status reports targeted for multiple request senders can through media (sub-)stream identification and OPID point to the same notification message, reducing the need to repeat applicable codec configuration parameters with every accepted request.

In general a COP message is sent from an end-point in it's role either as media receiver or media sender. Each message may comprise one or more message items of one or more message types, all originating from a single media source and (for some message items) targeted for a single media sender. The individual message items each mayrelate only to a single operation point. A general structure which may be embodied as an extension to AVPF is outlined below:

AVPF PSFB FMT=“COP”
SSRC of Packet Sender
SSRC of Media Source

COP Message Item 0
(Codec Configuration Parameters)
COP Message Item 1
(Codec Configuration Parameters)

...

Within this embodiment a Request is a COP Message Item may be sent in the media receiver role and makes use of “SSRC of Media Source” as the targeted media stream for the Request. Notification and Status Report Message Items may be sent in the media sender role, reporting on the message sender's own configuration and thus relate only to the “SSRC of Packet Sender”, and being agnostic to the “SSRC of Media Source” field. It is thus for example possible to co-locate COPS and COPN messages for the same media source in the same COP FCI.

The Codec Configuration Parameters that are applicable to a certain codec may be specific to the media type (audio, video, . . . ), but may also be codec-specific. Some codec properties (described by Codec Configuration Parameters) may be explicitly enabled by (non-COP) capability signaling to be possible or permitted to use. An end-point according to this embodiment need not support all available Codec Configuration Parameters proposed herein. E.g., a parameter may be uninteresting for a certain codec or media stream, even if it is generally supported by the end-point. The embodiment assumes capability signaling that allows a COP receiver to declare explicit support per parameter type on a per-codec level. The set of Codec Configuration Parameters that may be used for a certain media stream by a COP sender is thus restricted by the combination of applicability, capability signaling and explicit receiver parameter support signaling.

Any Codec Configuration Parameter that is applicable and feasible to use, but is not included as part of an Operation Point, may have a default value. This default may be defined per Parameter Type. Not including a specific Parameter Type in a media stream description or request can also implicitly be seen as an indication that it is either not interesting or not possible to describe or control the value explicitly, meaning that the effective value is “undefined” within the limits set by capability signaling.

The Codec Configuration Parameters comprised in a Message Item may jointly constitute a description of an Operation Point for a specific media stream from a media sender. For the purpose of COP signaling, each such Operation Point may be identified with an ID number, OPID, which may be scoped by the media sender's RTP identifications SSRC and Payload Type, and may be chosen freely by the media sender. A need for this media sub-stream identification basically may only appear with scalable coding or other media encoding methods that introduces separable and configurable sub-streams within the same SSRC and Payload Type. An OPID thus may refer to such configurable sub-stream, described by a set of related Codec Configuration Parameters.

Encoders dividing a media stream into sub-streams may include some means to identify those sub-streams in the media stream. However, it may be expected that such identification is in general codec-specific. Therefore, a need may arise to map the codec agnostic COP OPID identification to codec specific identification, and this solution therefore proposes a method for such mapping.

Within this embodiment another feedback message, COP, for codec control of real-time media is proposed, e.g. as an extension to the AVPF RFC 4585 and CCM RFC 5104 specifications. The AVPF specification outlines a mechanism for fast feedback messages over RTCP, which is applicable for IP based real-time media transport and communication services. It defines both transport layer and payload-specific feedback messages. This embodiment targets the payload-specific type, since a certain codec may be described by a payload type. AVPF defines three and CCM defines four payload-specific feedback messages (PSFB). All AVPF and CCM messages are identified by means of the feedback message type (FMT) parameter. This embodiment proposes another payload-specific feedback message. A new PSFB FMT value Codec Operation Point (COP) is therefore proposed.

The COP message may be a payload-specific AVPF CCM message identified by the PSFB FMT value listed above. It may carry one or more COP Message Items, each with either a request for or a description of a certain “Operation Point”; a set of codec parameters.

The “SSRC of packet sender” field within the common packet header for feedback messages (as defined in section 6.1 of RFC 4585), may indicate the message source. Not all Message Items may make use of the “SSRC of media source” in the common packet header. “SSRC of media source” may be set to 0 if no Message Item that makes use of it is included in the FCI.

The COP FCI may contain one or more Codec Operation Point Message Items. The maximum number of COP Message Items in a COP message may be limited, e.g. by the RFC 4585 Common Packet Format ‘length’ field. In general a COP Message Item Header Format may be as follows:

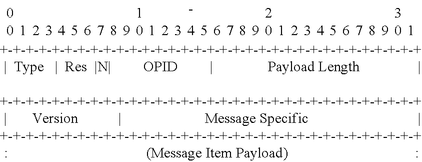

Exemplary message header fields are:
Type (e.g. 4 bits): Message Item Type. Three item types may be defined in this embodiment, COPR, COPN and COPS, with values as listed in the table below:

| Value | Message Item Type |
|---|---|
| 0 | Codec Operation Point Notification (COPN) |
| 1 | Codec Operation Point Request (COPR) |
| 2 | Codec Operation Point Status (COPS) |
| 3-14 | Unassigned |
| 15 | Reserved for future extensions |

More item types may be defined.
Res (e.g. 3 bits): Reserved for future extension. May be set to 0 by senders and may be ignored by receivers implementing this embodiment.
N (e.g. 1 bit): A “New OPID” flag, indicating that the OPID value may be chosen arbitrarily and is not meant to refer to any existing Operation Point. The message sender SHOULD NOT use an already known OPID in combination with the N flag. See also individual Message Item definitions.
OPID (e.g. 8 bits): Operation Point ID. Some (typically scalable) codecs may be capable of encoding into multiple simultaneous operation points using the same SSRC, and each operation point may then be referenced by OPID. May be unique within the scope of an SSRC when N flag is not set. May be set to 0 for message items not using the field.
Payload Length (e.g. 16 bits): The total length in bytes of all data belonging to this message, following the Payload Length field, including any Message Item Payload.
Version (e.g. 8 bits): Referencing a specific version of the Codec Configuration identified by the OPID.
Message Specific (e.g. 16 bits): Defined by individual Message Item Types.

Below an exemplary COPN format is shown:

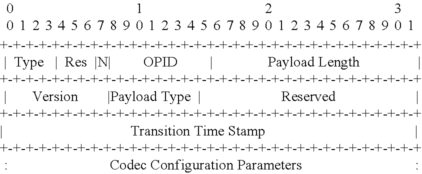

The COPN-specific message fields are:

Type (e.g. 4 bits): Set to 0, as listed in Table 1.

N (e.g. 1 bit): Not used by COPN and may be set to 0 by senders.

Version (e.g. 8 bits): Referencing a specific version of the Codec Configuration identified by the OPID. May be increased, e.g. by 1 modulo 2″8 whenever the used Codec Configuration referenced by the OPID is changed. A repeated message may not increase the Version. The initial value may be chosen randomly.

Payload Type (e.g. 7 bits): May be identical to the RTP header Payload Type valid for the (sub-)bitstream described by this OPID.

Reserved (e.g. 17 bits): May be set to 0 by senders and may be ignored by receivers implementing this solution. May be defined differently by extensions to this solution.

Transition Time Stamp (e.g. 32 bits): An RTP Time Stamp value when the listed Codec Configuration Parameters will be effective in the media stream, using the same timeline as RTP packets for the targeted SSRC. The Time Stamp value may express either a time in the past or in the future, and need not map exactly to an actual RTP Time Stamp present in an RTP packet for that SSRC.

Codec Configuration Parameters (e.g. variable length): Contains zero or more TLV carrying Codec Configuration Parameters as proposed in Parameter Types.

This message may be used to inform the media receiver(s) about used Codec Configuration Parameters at the media sender.

Some codecs may have clear inband indications in the encoded media stream of how one or more of the Codec Configuration Parameters are configured. For those codecs and Codec Configuration Parameters, COPN is not strictly necessary. Still, for some codecs and/or for some Codec Configuration Parameters, it is not unambiguously possible to see individual Codec Configuration Parameter Values from the encoded media stream, or even possible to see some Code Configuration Parameters at all, motivating use of COPN.

COPN may be scheduled for transmission when it becomes known that there are media receivers that did not yet receive any Codec Configuration Parameters for an active Operation Point, or whenever the effective Codec Configuration Parameters has changed significantly, but may be scheduled for transmission at any time. The media sender decides what amount of change is required to be considered significant.

The reason for a Codec Configuration Parameter change can either be local to the sending terminal, for example as a result of user interaction or some algorithmic decision, or resulting from reception of one or more COPR messages.

If a media sender can no longer fulfill the established Codec Configuration Parameter restrictions of a Operation Point that was previously described by a COPN, it may change any Codec Configuration Parameter or even remove the entire Operation Point, and may then signal this at the earliest opportunity by sending an updated COPN to the media receiver(s).

All Operation Points reported by a COPS may also be detailed by a subsequent COPN message, even if the Operation Point did not change significantly from previous COPN. Note that the OPID Version of that COPN, subsequent to COPS, may be larger than the Version indicated in the COPS, but the Version difference may be larger than one (taking field wraparound into account) depending on the number of updated COPN sent since the COPR that triggered the COPS.

Note: COPN may be seen as a more explicit and elaborate version of the TSTN message of RFC 5104 and most of the considerations detailed there for TSTN also apply to COPN.

The media sender decides what Codec Configuration Parameters to use in the COPN to describe an Operation Point. It is preferred that all Codec Configuration Parameters that were accepted as restrictions based on received COPR messages are included. All Codec Configuration parameters significantly more restrictive than implicit or explicit restrictions set by capability signaling may also be included. Any Codec Configuration Parameter that are either not applicable to the Payload Type or not enabled by capability signaling may not be included. All Codec Configuration Parameters not covered by the above restrictions may be included.

When the Operation Point has dependency to other Operation Points (such as in scalable coding), the values to use for Codec Configuration Parameters may describe the result when all dependencies are utilized. For example, assume an Operation Point describing a base layer with 15 Hz framerate, and a dependent Operation Point describing an enhancement layer adding another 15 Hz to the base layer, resulting in 30 Hz framerate when both layers are combined. The correct Parameter value to use for that latter, dependent “enhancement” Operation Point is 30 Hz, not the 15 Hz difference.

The value of a Codec Configuration Parameter that was not included in a COPN message may either be inferred from other signaling, e.g. session setup or capability negotiation or if such signaling is not available or not applicable, use the default value as proposed per Parameter Type.

An Operation Point describes one specific setting of Codec Parameters, and a COPN Message therefore may not include the OR Parameter Type in the Codec Parameters describing the Operation Point.

A COPN message containing an Operation Point without any Codec Configuration Parameters may be used to explicitly indicate that a previously present Operation Point is removed from the media stream.

To limit RTCP bandwidth and avoid bandwidth expansion, COPN is not mandated as response to every received COPR.

A media sender implementing this solution may take requested Operation Points from COPR messages into account for future encoding, but may decide to use other Codec Configuration Parameter Values than those requested, e.g. as a result of multiple (possibly contradicting)

COPR messages from different media receivers, or any media sender policies, rules or limitations. Thus, a COPN message Operation Point may use other Codec Configuration Parameters and other values than those requested in a COPR.

The media sender may try to maintain OPIDs between COPR and COPN when COPR sender suggests a new OPID value (N flag is set) in the COPR, but may use another OPID in COPN. Examples where other OPID values have to be chosen are for example when the suggested OPID conflicts with an already existing OPID, or when the media sender decides that a the suggested new OPID can be fulfilled by an already existing OPID.

Even if a COPR references an existing OPID (N flag cleared), the media sender may have to take other aspects than a specific COPR into account when choosing how many Operation Points to use, and the exact contents of those Operation Points. See the description on COPS on how to achieve mapping between a suggested new OPID and what OPID will actually be used.

When OPID cannot be kept the same between COPN and COPR, the mapping may be done using identical ID Parameters in the COPS and COPN resulting from the COPR.

Since COPR references a certain COPN OPID, Version and Payload Type, and COPN is send unreliably and may be lost, COPN senders may keep at least the two last COPN Versions for each SSRC, OPID, and Payload Type and may keep at least four.

The timing follows the rules outlined in section 3 of RFC 4585. This notification message may be time critical and may be sent using early or immediate feedback RTCP timing, but may be sent using regular RTCP timing.

A typical example when regular RTCP timing can be appropriate is when the sent media stream is further restricted from what was described by the most recent COPN, which may not cause any problems in the media receivers. Similarly, it is likely appropriate to use early or immediate timing when effective media stream restrictions urgently needs to be removed, which may require media receivers to increase their resource usage.

Any media sender, including Mixers and Translators, that sends RTP media marked with it's own SSRC and that implements this solution may also be prepared to send COPN, even if it is not the originating media source. As a result of that, such media sender may have to send updated COPN whenever the included media sources CSRC changes, subject to rules laid out above. Note that this can be achieved in different ways, for example by forwarding (possibly cached) COPN from the included CSRC when the Mixer is not performing transcoding.

In cases where a Mixer or Translator needs to forward a COPR in a step 100 from one side, e.g. EP1, via the Mixer in a step 400 towards the other side, e.g. SRC, the COPN sent in step 475 to EP1 MAY need to be delayed until the Mixer MX has received a corresponding COPN from the SRC in a step 450, as indicated in FIG. 3.

If a Mixer or Translator has decided to act partially, i.e. to modify the media stream with respect to some Parameter Types on a COPR received in a step 100 from EP1. The Mixer may then issue in a step 425 a COPN indicating those parameters which are not modified. If then a COPN is received in a step 450 from SRC indicating that the current media modifications are no longer necessary, the mixer or translator may cease it's own actions that are no longer needed. It may then also issue another COPN in a step 475 describing the new situation to EP1, as indicated in FIG. 4.

Below an exemplary COPR format is shown:

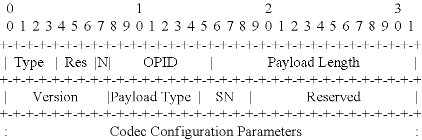

The COPR-specific message fields are:

Type (e.g. 4 bits): e.g. Set to 1, see above.

N (e.g. 1 bit): may be set to 0 when OPID references an existing OPID, Version and Payload Type announced in a COPN received from the targeted media sender, and may be set to 1 otherwise.

Version (e.g. 8 bits): When N flag is not set (0), referencing a specific version of the Codec Configuration identified by the OPID in a COPN received from the targeted media sender. Not used and may be set to 0 when N flag is set (1).

Payload Type (e.g. 7 bits): may be identical to the RTP header Payload Type valid for the (sub-) bitstream referenced by this OPID. Different Payload Types may not use the same OPID, unless there are otherwise insufficient number of unique OPID.

SN (e.g. 4 bits): Sequence Number. may be incremented by 1 modulo 2″4 for every COPR that includes an updated set of requested Codec Configuration Parameters described by the same OPID, Version, and Payload Type as was used with the previous SN. may be kept unchanged in repetitions of this message. Initial value may be chosen randomly.

Reserved (e.g. 16 bits): may be set to 0 by senders and may be ignored by receivers implementing this solution. may be defined differently.

Codec Configuration Parameters (e.g. variable length): Contains zero or more TLV carrying Codec Configuration Parameters as proposed in Parameter.

This Message Item is sent by a media receiver wanting to control one or more Codec Configuration Parameters for the specified Payload Type from the targeted media sender. The requested values may stay within the media capability negotiated by other means.

Note: COPR may be seen as a more explicit and elaborate version of the TSTR message of RFC 5104 and most of the considerations detailed there for TSTR also apply to COPR.

### Sender Behavior

If at least one COPN is received for the targeted stream, the Codec Configuration Parameters for that stream with defined OPID, Version and Payload Type are known to the COPR sender. The COPR may refer to the OPID, Version and Payload Type of the most recently received COPN (if any) for the targeted stream. Since it references a defined set of Codec Configuration Parameters from a COPN, the COPR may only include the Codec Configuration Parameters it wishes to change in the message, but it may include also unchanged Codec Configuration Parameters.

If no COPN is received for the targeted stream, the COPR sender may choose an arbitrary OPID and set the N flag to indicate that the OPID does not refer to any existing Operation Point. In this case the Version field is not used and may be set to 0. The OPID value may not be identical to any OPID from the same media source that the media receiver is aware of and has received COPN for. Since in this case no COPN reference exist, the COPR sender may include all Codec Configuration Parameters that it wishes to include a specific restriction for (other than the default). Note that for some codecs, some Codec Configuration Parameters may be possible to infer from the media stream, but if the wanted restriction includes also those and lacking a describing COPN, they may anyway be included explicitly in the COPR.

Any Codec Configuration Parameter that are either not applicable to the Payload Type or not enabled by capability signaling may not be included.

A COPR sender may increment the SN field e.g. modulo 2̂4 with every new COPR that includes any update to the Codec Configuration Parameters (referring to a specific OPID, Version, and Payload Type) compared to the previously sent SN, as long as it does not receive any COPS with the same OPID, Version, Payload Type, and SN as was used in the most recently sent COPR. COPR having a later SN may be interpreted as replacing COPR with identical OPID, Version, and Payload type but with previous SN, taking field wrap into account.

A COPR sender that did not receive any corresponding COPS, but did receive a COPN with the same OPID and Payload Type, and with a higher Version than was used in the last COPR may re-consider the COPR and MAY send an updated COPR referencing the new Version.

If the capability negotiation has established that a codec supporting scalable operation is used, and if the media receiver wishes to request that scalability is used, it may do so by sending multiple COPR with different OPID to the same media sender. The OPID and Version used in such request MAY be based on an existing Operation Point, but it may also indicate a desire to introduce scalability into a previously non-scalable stream by choosing a new OPID (indicated by setting the N flag). In any case, the resulting OPIDs and sub-streams are identified through use of the ID Parameter in subsequent COPS and COPN. See also the description of COPS.

An Operation Point without any Codec Configuration Parameters may be used and may be interpreted as releasing all previous restrictions on the Operation Point, effectively announcing that the Operation Point is no longer needed by the media receiver.

When an unchanged Operation Point needs to be indicated, it may be done through including only the ID Parameter as Codec Configuration Parameter.

When a COPR sender is receiving multiple Operation Points and wants to continue to do so, it may include all Operation Points it still wishes to receive in the COPR, also those that can be left unchanged.

Note: Sending a COPR using multiple OPID using different Payload Types to the same media sender is effectively requesting sub-streams using payload type multiplex, which may typically be used with care due to the many restrictions that has to be put on a RTP Payload Type multiplexed stream and is generally not preferred, unless with Payload Types that are specifically designed for multiplex such as for example Comfort Noise RFC 3389.

An COPR may also describe alternative Operation Points that the media sender can choose from, through use of one or more OR Parameters.

Since COPR references a specific COPN OPID, Version, and Payload Type, a COPR sender typically needs to keep the latest Version of received COPN for each SSRC, OPID, and Payload Type, also including the Codec Configuration Parameters.

### Receiver Behavior

A media sender receiving a COPR may take the request into account for future encoding, but may also take COPR from other media receivers and other information available to the media sender into account when deciding how to change encoding properties.

A media receiver sending COPR thus cannot always expect that all Parameter Values of the request are fully honored, or even honored at all. It can only know that the COPR was taken into account when receiving a COPS from the media sender with a matching OPID, Version, Payload Type and SN.

To what extent a COPR is honored is described by the chosen Codec Configuration Parameter values contained in a subsequent COPN message with a later (taking wraparound into account) Version than the one referred by the COPR.

### Timing Rules

The timing follows the rules outlined in section 3 of RFC 4585.

This request message may be time critical and may be sent using early or immediate feedback RTCP timing. The message may be sent with regular RTCP timing if it is known by the application that quick feedback is not required.

A COPR sender that did not receive a corresponding COPS MAY choose to re-transmit the COPR, without increasing the SN. When an RTP media receiver is timing out or leaves, it may implicitly imply that all COPR restrictions put by that media receiver are removed, just as if all the effective OPID were sent in COPR without Codec Configuration Parameters.

### Handling in Mixers and Translators

A Mixer or media Translator that implements this solution and encodes content sent to the media receiver issuing the COPR may consider the request to determine if it can fulfill it by changing its own encoding parameters. A Mixer encoding for multiple session participants will need to consider the joint needs of all participants when generating a COPR on its own behalf towards the media sender.

A Mixer or Translator able to fulfill the COPR partially may act on the parts it can fulfill (and may then send COPS and COPN accordingly), but may anyway forward the unaltered COPR towards the media sender, since it is likely most efficient to make the necessary Codec Configuration Parameter changes directly at the original media source.

A media Translator that does not act on COP messages will forward them unaltered, according to normal Translator rules.

Below an exemplary COPS format is shown:

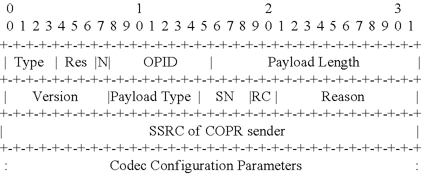

The COPS-specific message fields are:

SSRC of media source (e.g. 32 bits): Part of the COP header. Not used. May be set to 0.
Type (e.g. 4 bits): e.g. set to 2 (see above)
N (e.g. 1 bit): may be set identical to the same field in the COPR being reported on.
OPID (e.g. 8 bits): may be set identical to the same field in the COPR being reported on.
Version (e.g. 8 bits): may be set identical to the same field in the COPR being reported on.
Payload Type (e.g. 7 bits): may be set identical to the same field in the COPR being reported on.
SN (e.g. 4 bits): may be set identical to the same field in the COPR being reported on.
RC (e.g. 2 bits): Return Code. Indicates degree of success or failure of the COPR being reported on, as described below:

| Value | Meaning |
|---|---|
| 0 | Success |
| 1 | Partial success |
| 2 | Failure |
| 3 | Reserved for future extension |

A Success Return Code indicates that the resulting media configuration is fully in line with the COPR. A Partial Success Return Code indicates that the resulting media configuration is not fully in line with the COPR, but that the media sender regards the COPR to be sufficiently well represented by one or more of the existing Operation Points. A Failure Return code indicates that the media sender failed to take the COPR into account, either due to some error condition or because no media stream could be created or changed to comply.

Reason (e.g. 11 bits): Contains more detailed information on the reason for success or failure, as described below:

| Value | Meaning |
|---|---|
| 0 | Success |
| 1 | Too many Operation Points |
| 2 | Request violates capability limits |
| 3 | Unknown Parameter Type |
| 4 | Parameter Value too long |
| 5 | Invalid Comparison Type |
| 6 | Too old Operation Point Version |
| 7 | One or more parameter values in the request were changed |
| 8-2047 | Undefined |

The Reason Values proposed below are independent of Return Code, but all reasons may not be meaningful with all return codes. More reasons may be defined.

SSRC of COPR sender (e.g. 32 bits): may be set identical to the SSRC of packet sender field in the common AVPF header part of the COPR being reported on.

Codec Configuration Parameters (variable): may contain an ID Codec

Configuration Parameter providing codec specific media identification of the OPID, subject to conditions outlined in the text below, or may be empty.

The COPS Message Item indicates the request status of a certain OPID, Version, and Payload Type by listing the latest received COPR SN. It effectively informs the COPR sender that it no longer needs to re-send that COPR SN (or any previous SN).

COPS indicates that the specified COPR was successfully received. If the COPR suggested Codec Configuration Parameters could be understood, they may be taken into account, possibly together with COPR messages from other receivers and other aspects applicable to the specific media sender. The Return Code carries an indication to which extent the COPR could be honored.

COPS is typically sent without any Codec Configuration Parameters. When the N flag was set in the related COPR, a non-failing COPS may include an ID Parameter identifying the actual sub-stream that the media sender considers applicable to the COPR. The OPID used by that sub-stream can be found through examining ID Parameters of subsequent COPN from the same media source for ID values matching the one in COPS.

Senders implementing this solution may not use any other Codec Configuration Parameter Types than ID in a COPS message. The contained ID Parameter points to the specific media (sub-) stream that the media sender regards as applicable to the COPR.

When a COPR receiver has received multiple COPR messages from a single COPR source with the same OPID and Payload Type but with several different values of Version and/or SN, and for which it has not yet sent a COPS, it may only send COPS for the COPR with the highest Version and SN, taking field wrap of those two fields into account.

COPS may be sent at the earliest opportunity after having received a COPR, with the following exceptions:

1. A media sender that receives a COPR referencing an OPID, Version, and Payload Type for which it has sent a COPN with a later Version, may ignore the COPR. If that COPN was not sent closely to the COPR reception (longer than 2 times the longest observed round trip time, plus any AVPF-induced packet sending delays), it may re-send the latest COPN instead of sending a COPS.
2. A media sender that receives a COPR with a previously received OPID, Version, and SN closely after sending a COPS for that same OPID, Version, and SN (within 2 times the longest observed round trip time, plus any AVPF-induced packet sending delays), may await a repeated COPR before scheduling another COPS transmission for that OPID, Version, and SN.

The exceptions are introduced to avoid unnecessary COPS transmission when there is a chance that already sent COPS or COPN may satisfy or invalidate the COPR.

A Mixer or media Translator that implements this solution, encoding content sent to media receivers and that acts on COPR may also report using COPS, just like any other media sender. An RTP Translator not knowing or acting on COPR will forward all COP messages unaltered, according to normal RTP Translator rules.

### Parameter Types

COP Message Items may contain one or more Codec Parameters, e.g. encoded in TLV (Type-Length-Value) format, which may then be interpreted as simultaneously applicable to the defined Operation Point. Typically, the values are byte-aligned.

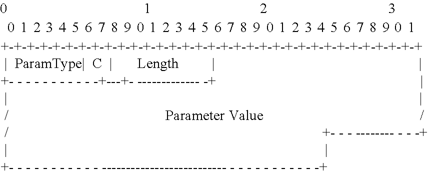

Param Type (e.g. 6 bits): A Codec Parameter Type, as proposed below and possible extensions to this invention. A receiver of a parameter with an unknown Param Type may ignore it, e.g. on reception in a COPN, and may either be reported as unknown in COPS or may be ignored when received in COPR.

| Value | Meaning | Tag |
|---|---|---|
| 0 | OR | or |
| 1 | ID | id |
| 2 | Bitrate | bitrate |
| 3 | Token Bucket Size | token-bucket |
| 4 | Framerate | framerate |
| 5 | Horizontal Pixels | hor-size |
| 6 | Vertical Pixels | ver-size |
| 7 | Channels | channels |
| 8 | Sampling Rate | sampling |
| 9 | Maximum RTP Packet Size | max-rtp-size |
| 10 | Maximum RTP Packet Rate | max-rtp-rate |
| 11 | Frame Aggregation | aggregate |
| 12 | Redundancy Level | red-level |
| 13 | Redundancy Offset | red-offset |
| 14 | Forward Error Correction Level | fec-level |
| 15-62 | Undefined | |
| 63 | Reserved for future extension | |

C (e.g. 2 bits): A Comparison Type, encoded as proposed below, unless specified otherwise by individual ParamType definitions. The Comparison Type specifies what type of restriction the Codec Configuration Parameter Value expresses and how it may be compared to other Codec Configuration Parameter Values of the same ParamType.

| Value | Meaning |
|---|---|
| 0 | Exact |
| 1 | Minimum |
| 2 | Maximum |
| 3 | Target |

Exact: The Parameter Value is an exact value, and no other values are acceptable. may not be used together with any other Comparison Types for the same ParamType.
Minimum: The Parameter Value is an inclusive minimum restriction. MAY be used together with Maximum and/or Target Comparison Types for the same ParamType. If no minimum restriction is specified, no specific minimum restriction exists.
Maximum: The Parameter Value is an inclusive maximum restriction. may be used together with Minimum and/or Target Comparison Types for the same ParamType. If no maximum restriction is specified, no specific maximum restriction exists.
Target: The Parameter Value is a preferred target value, but other values within a specified range are acceptable. This type may be used together with at least one of Minimum and Maximum Comparison Types for the same ParamType. If no target is specified, no specific preference exists.
Length (e.g. 8 bits): The Parameter Value Length in bytes.
Parameter Value (e.g. variable length): The actual parameter value, encoded in a format proposed by the specific Param Type definition.
If multiple Codec Parameters with the same Param Type are included in the same COP Message, Codec Parameters appearing towards the end of the Codec Parameter list may override Codec Parameters that appeared earlier in the list, unless other semantics are explicitly proposed for that Codec Parameter.
A Codec Parameter that is encoded in a way (including incorrectly) that cannot be interpreted by the receiver may be ignored.

### Parameter Type Values

In the following different exemplary parameter types are described. These parameters may describe a codec property to be controlled for a certain operation point.

Typically all Codec Parameter values are binary encoded, whereby the most significant byte is typically first (in case of multi-byte values).

### OR

This Codec Parameter Type is a special parameter, separating the Codec Configuration Parameters preceding it from the ones that follow into two separate, alternative Operation Points. It may therefore also be referred to as ALT.

A special parameter expressing an OR relation between the parameters preceding it and the parameters following it. This may be interpreted as describing two alternate Operation Points where one and only one may be chosen, with the Operation Point preceding OR in the parameter list being preferred. Multiple OR parameters may be used in the same parameter list, in which case each set of parameters to evaluate can be either before the first OR parameter, between two OR parameters, or after the last OR parameter. Evaluating from the top of the list and obeying the above preference rule, the first acceptable set of parameters (not containing any OR parameter) may be the one to choose.

### ID

This Codec Parameter Type is a special parameter that enables codec specific identification of sub-streams, for example when there are multiple sub-streams in a single SSRC. It can also be used to reference OPID, when the used codec does not support or use sub-streams. When used, it may be listed first among the Codec Parameters used to describe the sub-stream.

A special parameter describing the, possibly codec specific, media identification for the OPID. If used with non-scalable encoding, it may contain an OPID. may be proposed to occupy an integer number of bytes, where all bits in the bytes are proposed as part of the format.

If used with non-scalable encoding, any OPID restrictions apply. may be used whenever there is a need to identify an Operation Point in codec native format, or when there is a need to map that against an OPID.

### Bitrate

The transport level average media bitrate value (similar to b=AS from SDP) may be expressed in bits/s. Also a value of 0 may be used. This property may be held generally valid for all media types.

### Token Bucket Size

The transport level token bucket size, may be expressed in bytes. This property may be held generally valid for all media types. Note that changing a token bucket size does not change the average bitrate, it just changes the acceptable average bitrate variation over time. A value of 0 is generally not meaningful and may not be used. This parameter used with a maximum comparison type parameter may be significantly similar to CCM Temporary Maximum Media Bit Rate (TMMBR). When being used with a maximum comparison type value of 0, it is also significantly similar to PAUSE [I-D.westerlund-avtext-rtp-stream-pause]. Compared to those, this parameter conveys significant extra information through the relation to other parameters applied to the same Operation Point, as well as the ability to express other restrictions than a maximum limit. When CCM TMMBR is supported, the Bitrate parameters from all Operation Points within each SSRC should be considered and CCM TMMBR messages may be sent for those SSRC that are found to be in the bounding set (see CCM [RFC5104], section 3.5.4.2). When PAUSE is supported, the Bitrate parameters from all Operation Points within each SSRC should be considered and CCM PAUSE messages may be sent for those SSRC that contain only Operation Points that are limited by a Bitrate maximum value of 0.

### Framerate

A media frame is typically a set of semantically grouped samples, i.e. the same relation that a video image has to its individual pixels and an audio frame has to individual audio samples. A media framerate may be expressed in 100th of a Hz. A value of 0 may be used. This property is mainly intended for video and timed image media, but may be used also for other media types. Note that the value applies to encoded media framerate, not the packet rate that may be changed as a result of different Frame Aggregation.

### Horizontal Pixels

The horizontal pixels describes horizontal image size in pixels. This property may be used for video and image media.

### Vertical Pixels

The vertical pixels describes horizontal image size in pixels. This property may be used for video and image media.

### Channels

Channels may describe a number of media channels. E.g. for audio, an interpretation and spatial mapping may follow RFC 3551, unless explicitly negotiated, e.g. via SDP. For video, it may be interpreted as the number of views in multi-view coding, e.g. where a number of 2 may represent stereo (3D) coding, unless negotiated otherwise, e.g. via SDP.

Obviously, it does not make sense to use such a parameter if the concerned multi-channel coding is not supported by both ends.

### Sampling Rate

The sampling rate may describe the frequency of the media sampling clock in Hz, per channel. A sampling rate is mainly intended for audio media, but may be used for other media types. If multiple channels are used and different channels use different sampling rates, this parameter may be used unless there is a known sampling rate relationship between the channels that is negotiated using other means, in which case the sampling rate value may applies to the first channel only.

Note, typically only a limited subset of sampling frequencies makes sense to the media encoder, and sometimes it is not possible to change the sampling rate at all. For video, the sampling rate is very closely related to the image horizontal and vertical resolution, which are more explicit and which are more appropriate for the purpose. For audio, changing sampling rate may require changing codec and thus changing RTP payload type.

Note, the actual media sampling rate may not be identical to the sampling rate specified for RTP Time Stamps. E.g. almost all video codecs only use 90 000 Hz sampling clock for RTP Time Stamps. Also some recent audio codecs use an RTP Time Stamp rate that differs from the actual media sampling rate.

Note that the value is the media sample clock and may not be mixed up with the media Framerate.

### Maximum RTP Packet Size

The maximum RTP packet size is the maximum number of bytes to be included in an RTP packet, including the RTP header but excluding lower layers. This parameter MAY be used with any media type. The parameter may typically be used to adapt encoding to a known or assumed MTU limitation, and MAY be used to assist MTU path discovery in point-to-point as well as in RTP Mixer or Translator topologies.

### Maximum RTP Packet Rate

The maximum RTP Packet Rate is the maximum number of RTP packets per second. This parameter MAY be used with any media type. The parameter may typically be used to adapt encoding on a network that is packet rate rather than bitrate limited, if such property is known. This Codec Parameter may not exceed any negotiated “maxprate” RFC 3890 value, if present.

### Frame Aggregation

The frame aggregation describes how many milliseconds of non-redundant media frames representing different RTP Time Stamps that may be included in the RTP payload, called a frame aggregate. Frame aggregation is mainly intended for audio, but MAY be used also for other media. Note that some payload formats (typically video) do not allow multiple media frames (representing different sampling times) in the RTP payload.

This Codec Parameter may not be used unless the “maxprate” RFC 3890 and/or “ptime” parameters are included in the SDP. The requested frame aggregation level may not cause exceeding the negotiated “maxprate” value, if present, and may not exceed the negotiated “ptime” value, if present. The requested frame aggregation level may not be in conflict with any Maximum RTP Packet Size or Maximum RTP Packet Rate parameters.

Note that the packet rate that may result from different frame aggregation values is related to, but not the same as media Framerate.

### Redundancy Level

The redundancy level describes the fraction of redundancy to use, relative to the amount of non-redundant data. The fraction is encoded as two binary encoded 8-bit values, one numerator and one denominator value. The fraction may be expressed with the smallest possible nominator and denominator values.

This Codec Parameter may not be used if the capability negotiation did not establish that redundancy is supported by both ends. The redundancy format to use, e.g. RFC 2198, may be negotiated via other means. What is meant by fractional redundancy levels, e.g. if one of N media frames are repeated or if partial (more important part of) media frames are repeated may be negotiated via other means.

The redundancy level may be used with any media, but is mainly intended for audio media.

The requested redundancy level likely impacts transport level bitrate, token bucket size, and RTP packet size, and may not be in conflict with any of those parameters.

### Redundancy Offset

The redundancy offset describes the time distance between the most recent data and the redundant data, expressed in number of “frame aggregates”, encoded as a list of binary encoded 8-bit numbers, where the value 0 represents the most recent data. Note that the number of offsets impacts the redundancy level and the two parameters may be correctly aligned. Specifically, specifying a Redundancy Offset implies that Redundancy Level cannot be 0.

The redundancy offset may be used with any media, but is mainly intended for audio media.

### Forward Error Correction Level

The forward error correction level describes the fraction of FEC data to use, relative to the amount of non-redundant and non-FEC data. The fraction is encoded as two binary encoded 8-bit values, one numerator and one denominator value. The fraction may be expressed with the smallest possible nominator and denominator values.

This Codec Parameter may not be used if the capability negotiation did not establish that FEC is supported by both ends. The FEC format to use, e.g. RFC 5109, may be negotiated via other means.

The forward error correction level may be used with any media.

The requested FEC level likely impacts transport level bitrate, token bucket size, and RTP packet size, and may not be in conflict with any of those parameters.

As described in RFC 4585 and RFC 5104, the rtcp-fb attribute may be used to negotiate capability to handle specific AVPF commands and indications, and specifically the “ccm” feedback value is used for codec control. All rules proposed there related to use of “rtcp-fb” and “ccm” also apply to the proposed feedback message.

Hence, a “ccm” rtcp-fb-ccm-param may be proposed, according to the method of extension described in RFC 5104:

o “cop” indicates support for all COP Message Items proposed in this solution, and one or more of the Codec Configuration Parameters proposed in this solution.

The ABNF RFC 5234 for the proposed rtcp-fb-ccm-param may be:

```
rtcp-fb-ccm-param =/ SP ″cop″ 1*rtcp-fb-ccm-cop-param
; rtcp-fb-ccm-param defined in [RFC5104]
rtcp-fb-ccm-cop-param = SP ″and″
  / SP ″or″
  / SP ″id″
  / SP ″bitrate″
  / SP ″token-bucket″
  / SP ″framerate″
  / SP ″hor-size″
  / SP ″ver-size″
  / SP ″channels″
  / SP ″sampling″
  / SP ″max-rtp-size″
  / SP ″max-rtp-rate″
  / SP ″aggregate″
  / SP ″red-level″
  / SP ″red-offset″
  / SP ″fec-level″
  / SP token ; for future extensions
; token defined in [RFC45666]
```

The usage of Offer/Answer RFC 3264 in this solution inherits all applicable usage defined in RFC 5104. An offer or answer desiring to announce capability for the CCM “cop” feedback message in SDP may indicate that capability through use of the CCM parameter. The offer and answer may also include a list of the Parameter Types that the offerer or answerer, respectively, is willing to receive. An answerer not supporting COP will remove the “cop” CCM parameter, in line with general SDP rules as well as what is outlined in RFC 5104.

The answer may add and/or remove Parameter Types compared to what was in the offer, to indicate what the answerer is willing to receive. That is, the offer and answer do not explicitly list any COP Parameter Type sender capability. The offerer and the answerer may not send any Parameter Types that the remote party did not indicate receive support for.

The proposed mechanism is not bound to a specific codec. It uses the main characteristics of a chosen set of media types, including audio and video. To what extent this mechanism can be applied depends on which specific codec is used. When using a codec that can produce separate sub-streams within a single SSRC, those sub-streams may be referred with a COP OPID if there is a defined relation to the codec-specific sub-stream identification. This may be accomplished in this specification by defining an ID Parameter format using codec-specific sub-stream identification for each such codec.

This section contains ID Parameter format definitions for exemplary codecs. The format definitions may use an integer number of bytes and may propose all bits in those bytes. Extensions to this solution may add more codec-specific definitions than the ones described in the sub-sections below.

### H.264 AVC

Some non-scalable video codecs such as H.264 AVC and corresponding RTP payload format RFC 6184 can accomplish simultaneous encoding of multiple operation points. H.264 AVC can encode a video stream using limited-reference and non-reference frames such that it enables limited temporal scalability, by use of the nal_ref_id syntax element.

The ID Parameter Type is proposed below:

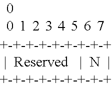

Reserved (e.g. 6 bits): Reserved. May be set to 0 by senders and may be ignored by receivers implementing this memo.

N (e.g. 2 bits): may be identical to the nal_ref_idc H.264 NAL header syntax element valid for the sub-bitstream described by this OPID.

### H.264 SVC

This application specifies the usage of multiple codec operation points and therefore maps well to scalable video coding. Scalable video coding such as H.264 SVC (Annex G) may use three scalability dimensions: temporal, spatial, and quality.

The ID may be considered describing an SVC sub-bitstream, which is defined in G.3.59 of H.264 and corresponding RTP payload format RFC 6190. For use with H.264 SVC, ID may be constructed as proposed below:

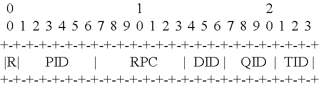

R (e.g. 1 bit): Reserved. May be set to 0 by senders and may be ignored by receivers implementing this memo.
PID (e.g. 6 bits). May be identical to an unsigned binary integer representation of the priority_id H.264 syntax element valid for the sub-bitstream described by this OPID. SHALL be set to 0 if no priority_id is available.
RPC (e.g. 7 bits). May be identical to an unsigned binary integer representation of the redundant_pic_cnt H.264 syntax element valid for the sub-bitstream described by this OPID. may be set to 0 if no redundant_pic_cnt is available.
DID (e.g. 3 bits). May be identical to the dependency_id H.264 syntax element valid for the sub-bitstream described by this OPID.
QID (e.g. 4 bits). May be identical to the quality_id H.264 syntax element valid for the sub-bitstream described by this OPID.
TID (e.g. 3 bits). May be identical to the temporal_id H.264 syntax element valid for the sub-bitstream described by this OPID

In the following some examples will be briefly discussed indicating several use cases

Although COP messages may be binary encoded, in the following examples, all COP messages are for clarity listed in symbolic, pseudo-code form, where only COP message fields of interest to the example are included, along with the COP Parameters.

The SDP capabilities for COP may be defined as receiver capabilities, meaning that there is no explicit indication what COP messages an end-point will use in the send direction. However one may also foresee that an end-point may also send like messages that it can understand and act on when received. This assumption may also be followed in the SDP examples below, but note that symmetric COP capabilities is not a requirement.

The example below shows an SDP Offer, where support of CCM “cop” message is announced for the video codecs.

v=0
o=alice 2890844526 2890844526 IN IP4 host.atlanta.com
s=−
c=IN IP4 host.atlanta.com
t=0 0
m=audio 10000 RTP/AVP 0 8 97
b=AS:80
a=rtpmap:0 PCMU/8000
a=rtpmap:8 PCMA/8000
a=rtpmap:97 iLBC/8000
m=video 10010 RTP/AVPF 31 32
b=AS:600
a=rtpmap:31 H261/90000
a=rtpmap:32 MPV/90000
a=rtcp-fb:31 ccm cop framerate bitrate token-rate
a=rtcp-fb:32 ccm cop hor-size ver-size framerate bitrate \ token-rate

Note that the exemplary offer comprises two different video payload types, and that the COP Parameters differ between them, meaning that the possibility for codec configuration also differ. In this case, the MPEG-1 codec can control both framerate and image size, but for H.261 only the framerate can be controlled. In the SDP Answer below, responding to the above offer, the answerer supports CCM “cop” messages.

v=0
o=bob 2808844564 2808844564 IN IP4 host.biloxi.com
s=−
c=IN IP4 host.biloxi.com
t=0 0
m=audio 20000 RTP/AVP 0
b=AS:80
a=rtpmap:0 PCMU/8000
m=video 20100 RTP/AVPF 32
b=AS:600
a=rtpmap:32 MPV/90000
a=rtcp-fb:32 ccm cop hor-size ver-size framerate bitrate \ token-rate packet-size

Note that the answerer indicates support for more parameter types than the offerer.

Below is another SDP Answer, also responding to the same offer above, where the answerer does not support “cop”.

v=0
o=bob 2808844564 2808844564 IN IP4 host.biloxi.com
s=−
c=IN IP4 host.biloxi.com
t=0 0
m=audio 20000 RTP/AVP 0
b=AS:80
a=rtpmap:0 PCMU/8000
m=video 20100 RTP/AVPF 32
b=AS:600
a=rtpmap:32 MPV/90000

### Dynamic Video Re-Sizing

In this example, two COP-enabled end-points communicate in an audio/video session. The receiving end-point has a graphical user interface that can be dynamically changed by the user. This user interaction includes the ability to change the size of the receiving video window, which is also indicated in the previous SDP example. At some point during the established communication, a notification about current video stream Codec Operation Point is sent to the resizable window end-point that receives the video stream.

### COPN {OPID:123, Version:5,

bitrate(exact):325000,
token-bucket(exact):1000,
framerate(exact):15,
hor-size(exact):320,
ver-size(exact):240}

Sometimes later the user of the resizable window end-point reduces the size of the video window. As a result of the resize operation, the video window can no longer make full use of the received video resolution, wasting bandwidth and decoder processing resources. The resizable window end-point thus decides to notify the video stream sender about the nged conditions by sending a request for a video

stream of smaller size:

### COPR {OPID:123, Version:5,

hor-size(target):243,
ver-size(target):185}

The COPR refers to the previously received COPN with the same OPID and Version, and thus need only list parameters that need be changed. The request could arguably contain also other parameters that are potentially affected by the spatial resolution, such as the bitrate, but that can be omitted since the media sender is not slaved to the request but is allowed to make it's own decisions based on the request. The request sender has chosen to use target type values instead of an exact value for the horizontal and vertical sizes, which can be interpreted as “anything sufficiently similar is acceptable”. The target values is in this example chosen to correspond exactly to the resized video display area. Many video coding algorithms operate most efficiently when the image size is some even multiple, and this way of expressing the request explicitly leaves room for the media sender to take such aspect into account.

The media sender (COPR receiver) responds with the following:

### COPS {OPID:123, Version:5,

### Partial Success,

One or more parameter values in the request were changed}

### COPN {OPID:123, Version:6,

bitrate(exact):240000,
token-bucket(exact):1000,
framerate(exact):15,
hor-size(exact):240,
ver-size(exact):176}

It can be noted that the updated COPN (version 6) indicates that the media sender has, in addition to reducing the video horizontal and vertical size, chosen to also reduce the bitrate. This bitrate reduction was not in the request, but is a reasonable decision taken by the media sender. It can also be seen that the horizontal and vertical sizes are not chosen identical to the request, but is in fact adjusted to be even multiples of 16, which is a local restriction of the fictitious video encoder in this example. To handle the mismatch of the request and the resulting video stream, the video receiver can perform some local action such as for example automatic re-adjustment of the resized window, image scaling (possibly combined with cropping), or padding.

### Illegal Request

In this example, the sent request is asking the media sender to go beyond what is negotiated in the SDP. The SDP Offer below indicates to use video with H.264 Constrained Baseline Profile at level 1.1.

v=0
o=alice 2893746526 2893746526 IN IP4 host.atlanta.com
s=−
c=IN IP4 host.atlanta.com
t=0 0
m=audio 49160 RTP/AVP 96
b=AS:80
a=rtpmap:96 G722/16000
m=video 51920 RTP/AVPF 97
b=AS:200
a=rtpmap:97 H264/90000
a=fmtp:97 profile-level-id=42e00b
a=rtcp-fb:97 ccm cop framerate bitrate token-rate

Assuming this offer is accepted and that the answerer also supports COP, further assume that this COP message exchange occurs at some time during the established communication:

from Media Sender to Media Receiver

### COPN {OPID:67, Version:2, ->

bitrate(exact):190000,
token-bucket(exact):500,
framerate(exact):10,
hor-size(exact):320,
ver-size(exact):240}
from Media Receiver to Media Sender

### <-COPR {OPID:67, Version:2,

framerate(exact):10,
hor-size(exact):352,
ver-size(exact):288}
from Media Sender to Media Receiver

### COPS {OPID:67, Version:2, ->

### Failure,

Request violates capability limits}

The failure above is due to a combination of frame size and frame rate that exceeds H.264 level 1.1, which would thus exceed the limits established by SDP Offer/Answer. The maximum permitted framerate for 352×288 pixels (CIF) is 7.6 Hz for H.264 level 1.1, as defined in Annex A of H264.

### Reference Response to Modification of Scalable Layer

When scalable coding is used, each layer corresponds to a Codec Operation Point. A media receiver can thus target a request towards a single layer. Assume a video encoding with three framerate layers, announced in a (multiple operation point) notification as:

### COPN {OPID:67, Version:2, ID:2

bitrate(exact):190000,
token-bucket(exact):500,
framerate(exact):10,
hor-size(exact):320,
ver-size(exact):240}

### COPN {OPID:73, Version:1,

bitrate(exact):350000, ID:1
token-bucket(exact):600,
framerate(exact):30,
hor-size(exact):320,
ver-size(exact):240}

### COPN {OPID:95, Version:5, ID:0

bitrate(exact):400000,
token-bucket(exact):800,
framerate(exact):60,
hor-size(exact):320,
ver-size(exact):240}

Assume further that the media receiver is not pleased with the low framerate of OPID 67, wanting to increase it from 10 Hz to 25-30 Hz. Note that the media receiver still wants to receive the other layers unchanged, not remove them, and thus has to explicitly indicate this by including them with only the ID parameter present.

### COPR {OPID:67, Version:2,

framerate(greater):25,
framerate(less):30}

### COPR {OPID:73, Version:1, ID:1}

### COPR {OPID:95, Version:5: ID:0}

The media sender decides it cannot meet the request for OPID 67, but instead considers (an unmodified) OPID 73 (with ID 1) to be a sufficiently good match:

### COPS {OPID:67, Version:2,

### Partial Success,

One or more parameter values in the request were changed,

### ID:1}

(COPN for the other two OPIDs omitted here for brevity and clarity)

### COPN {OPID:73, Version:1, ID:1

bitrate(exact):350000,
token-bucket(exact):600,
framerate(exact):30,
hor-size(exact):320,
ver-size(exact):240}

The COPS indicates partial success and uses the ID number to refer another OPID, describing the best compromise that can currently be used to meet the request. COPS does not contain the referred OPID, but ID should be defined in a codec-specific way that makes it possible to identify the layer directly in the media stream. If the corresponding PID is needed, for example to attempt another request targeting that, it can be found by searching the active set of COPN for matching ID values.

### Successful Request to Add Codec Operation Point

In this example, the media receiver is receiving a non-scalable stream from a codec that can support scalability, and wishes to add a scalability layer. Assume the existing OPID from the media sender is announced as:

### COPN {OPID:4, Version:2,

bitrate(exact):350000,
token-bucket(exact):600,
framerate(exact):30,
hor-size(exact):320,
ver-size(exact):240}

The media receiver constructs a request for multiple streams by including multiple requests for different OPID. Since the new stream does not exist, it has no OPID from the media sender and the receiver chooses a random value as reference and indicates that it is a new, temporary OPID. The request for the new stream includes all parameters that the media receiver has an opinion on, and leaves the other parameters to be chosen by the media sender. In this case it is a request for identical frame size and doubled framerate.

### COPR {OPID:73, Version:1,

framerate(exact):30,
hor-size(exact):320,
ver-size(exact):240}

### COPR {OPID:237, New, Version:0,

framerate(exact):60,
hor-size(exact):320,
ver-size(exact):240}

The media sender decides it can start layered encoding with the requested parameters. The status response to the new OPID contains a reference to an ID that is included as part of the matching, subsequent COPN. Note that since both the original and the new streams are now part of a scalable set, they must both be identified with ID parameters to be able to distinguish between them. The media sender has chosen an OPID for the new stream in the COPN, which need not be identical to the temporary one in the request, but the new stream can anyway be uniquely identified through the ID that is announced in both the COPS and COPN. Note that since the ID has a defined relation to the media sub-stream identification, decoding of that new sub-stream can start immediately after receiving the COPS. It may however not be possible to describe the new stream in COP parameter terms until the COPN is received (depending on COP parameter visibility directly in the media stream).

### COPS {OPID:237, New, Version:0,

### Success, Success,

### ID:0}

### COPN {OPID:4, Version:2, ID:1,

bitrate(exact):350000,
token-bucket(exact):600,
framerate(exact):30,
hor-size(exact):320,
ver-size(exact):240}

### COPN {OPID:9, Version:0, ID:0,

bitrate(exact):390000,
token-bucket(exact):600,
framerate(exact):60,
hor-size(exact):320,
ver-size(exact):240}

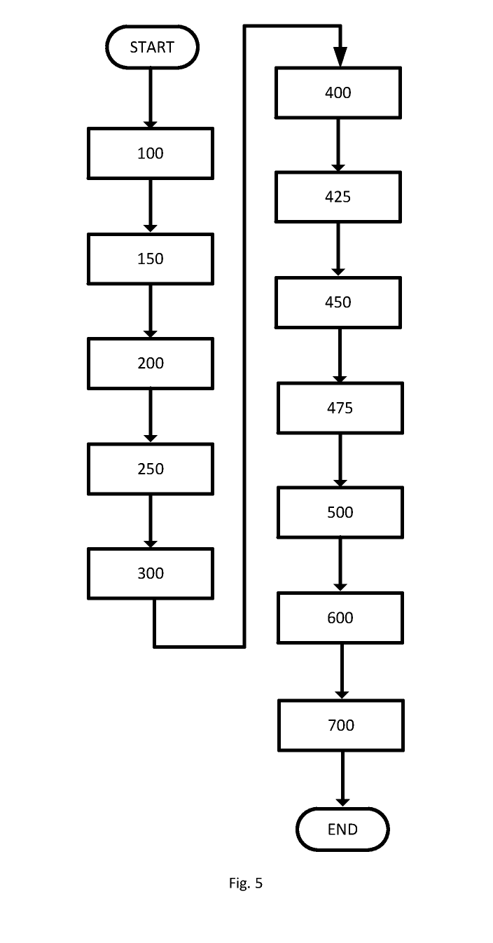

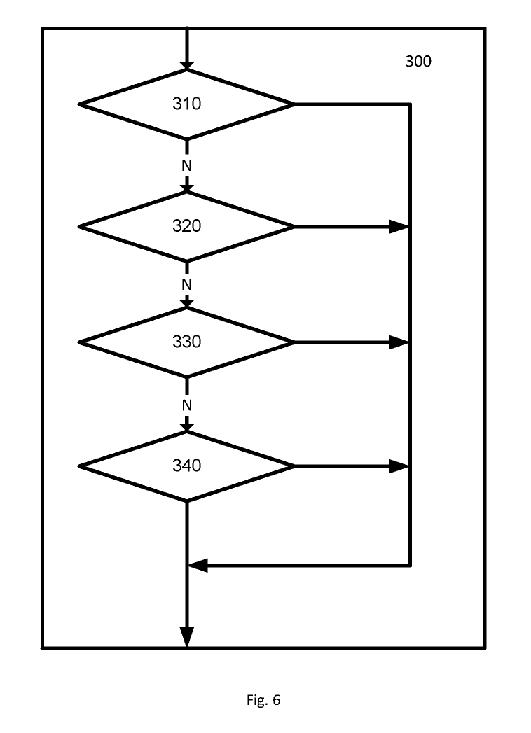

An exemplary method is shown in FIG. 5 and FIG. 6, whereby some steps are optional and the exact sequence may be different. For ease of understanding it is assumed that only two Endpoints EP1 and EP2 as shown in FIG. 1 are requesting media streams originating from a media source SRC.

There in a step 100 a mixer MX receives a first request COPR1 of a first endpoint EP1. In a step 200 the mixer MX receives a second request set COPR2 of a second endpoint EP2. As already detailed a request set comprises information relating to at least a subset of one or more codec parameters, and a request set pertains to a media stream. Both request sets COPR1 and COPR2 pertain to a same media content.

Preferably said request sets COPR1 and COPR2 are provided within one or more Codec Operation Point Request messages.

Both requests may optionally, i.e. subject to implementation, be acknowledged in a respective message 150 directed to said first endpoint EP1 and/or message 250 directed to said send endpoint EP2. Such a message may be embodied in Codec Operation Point Acknowledgement message.

Once the requests COPR1 and COPR2 are received, they are aggregated in a step 300 into an aggregated request set COPRA pertaining to a first media source SRC.

Said aggregated request set COPRA is send in step 400 towards said first media source SRC. At the SRC, which may also be another Mixer, the request is processed. In the following, we will assume that the SRC is actually providing the requested media stream, i.e. the source is e.g. an encoder.

Preferably said request set COPRA is provided within one or more Codec Operation Point Request messages.

Subject to implementation the respective aggregated information relating to said first request set COPR1 is signaled towards said first endpoint EP1 within one or more Codec Operation Point Notification COPN message(s) in a step 425 or 475. For additional details, see description relating to FIGS. 3 and 4.

In particular, subject to implementation, a change of aggregated information relating to said first request set COPR1 is signaled towards said first endpoint EP1 within one or more one Codec Operation Point Notification COPN message(s) in a step 475. For additional details, see description relating to FIGS. 3 and 4.

The first media source SRC is now starting to stream the requested content, i.e. the requested media stream, and consequently the mixer MX is receiving in a step 500 said requested media stream from said first media source SRC.

The mixer MX is delivering in a step 600 a first media stream towards said first endpoint EP1 according to the first request set COPR1 and in a step 700 delivering a second media stream towards said second endpoint EP2 according to the second request set COPR2.

The step of aggregating 300 may comprise several steps as will be detailed in the following.

E.g. in a step 310 it may be determined if the first request set towards a particular media stream and the second request set towards said particular media stream are identical. If the condition is fulfilled only one request set towards said particular media stream is provided within the aggregated request set COPRA.

E.g. in a step 320 it may be determined if an information relating to at least a subset of one or more codec parameters within said first request set COPR1 towards a particular media stream is not present in said information relating to at least a subset of one or more codec parameters within said second request set COPR2 towards said particular media stream. If the condition is fulfilled the information of the request sets is combined such that each information is present at least once within the aggregated request set COPRA.

E.g. in a step 330 it may be determined if an information relating to at least a subset of one or more codec parameters within said first request set COPR1 towards a particular media stream is also present in said information relating to at least a subset of one or more codec parameters within said second request set COPR2 towards said particular media stream but the information is deviating from one another. If the condition is fulfilled it may then be determined if the deviating information is pertaining to a maximum constraint. If this condition is fulfilled the information of the request sets is combined such that the information pertaining to a lower requirement is present within the aggregated request set COPRA.

E.g. in a step 340 it may be determined if an information relating to at least a subset of one or more codec parameters within said first request set COPR1 towards a particular media stream is also present in said information relating to at least a subset of one or more codec parameters within said second request set COPR2 towards said particular media stream but the information is deviating from one another. If the condition is fulfilled it may then be determined if the deviating information is pertaining to a minimum constraint. If this condition is fulfilled the information of the request sets is combined such that the information pertaining to a higher requirement is present within the aggregated request set COPRA.

Obviously, these steps 330 and 340 may be combined.

In a preferred embodiment the media stream comprises a scalable encoding. Consequently said portions of said media streams being delivered towards said endpoints in steps 600 and 700 according to the respective request set are scalable portions of said media streams, e.g. where said first media stream comprises only portions of said second media stream or vice versa, i.e. EP1 may only receive a base layer, while EP2 would receive also further layers.

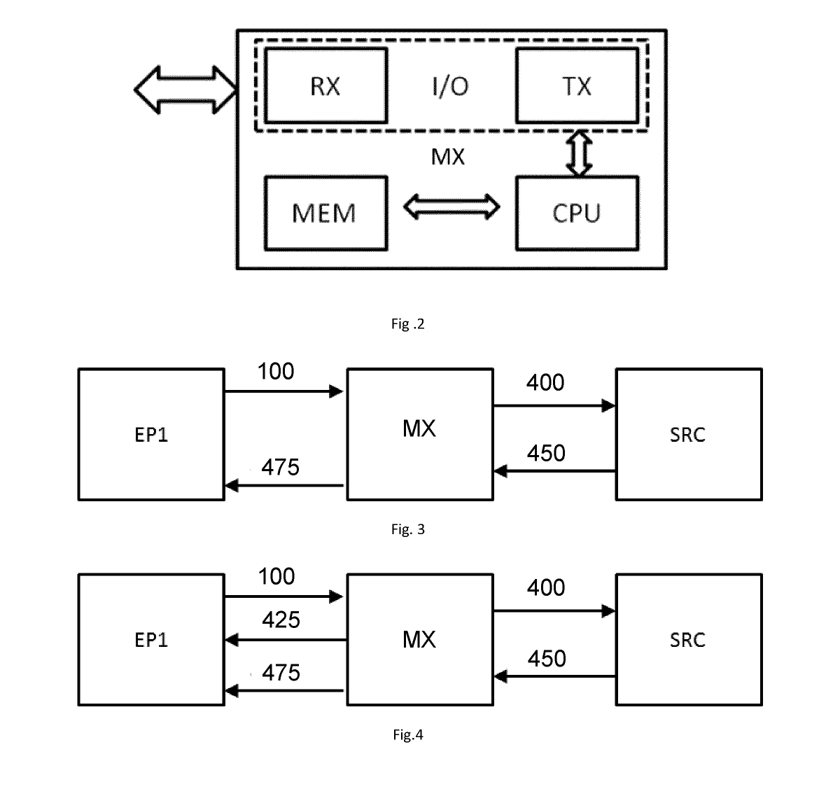

Consequently, a Mixer MX for providing media streams towards a plurality of endpoints EP1, EP2, EP3, EP4, the media streams originating from one or more media source SRC may be arranged as shown in FIG. 2. For ease of understanding it is assumed that only two Endpoints EP1 and EP2 as shown in FIG. 1 are requesting media streams originating from a media source SRC.

The Mixer MX comprises a receiver RX adapted for receiving at least a first request set COPR1 of a first endpoint EP1 and a second request set COPR2 of a second endpoint EP2 of said plurality of endpoints, whereby a request set comprises information relating to at least a subset of one or more codec parameters, and whereby a request set pertains to a media stream, whereby said first request set and said second request set pertain to a same media content.

Said receiver RX may be embodied in any suitable receiver arrangement such as a receiver portion of a Network Interface and may be understood as a part of an I/O unit.

Furthermore, the Mixer MX comprises a control unit CPU for aggregating said received first request set COPR 1 and said received second request set COPR2 into an aggregated request set COPRA pertaining to a first media source SRC.

Said control unit CPU may be embodied in a suitable processor or microcontroller, such as a microcontroller or microprocessor or an application-specific integrated circuit (ASIC) or an Field Programmable Gate Array (FPGA).

Furthermore, the Mixer MX comprises a sender TX adapted for requesting a media stream according to said aggregated request set COPRA from said first media source SRC,

Said Sender TX may be embodied in any suitable sender arrangement such as a sender portion of a Network Interface and may be understood as a part of an I/O unit.

Subject to the implementation, i.e. if downlink and uplink are relating to different networks, it may also be envisaged that the respective sender TX and RX are separate units.

The receiver RX is further adapted for receiving said requested media stream from said first media source SRC and whereby said sender TX is further adapted for delivering a first media stream towards said first endpoint EP1 according to the first request set COPR1 and whereby said sender TX is further adapted for delivering a second media streams towards said second endpoint EP2 according to the second request set COPR2.

The Mixer MX may also comprise Memory MEM which allows for storing request sets COPR1, COPR2, COPRA as well as may be arranged such that it may allow a mixer MX in connection with its control unit CPU to perform transcoding if necessary.

Further details of the Mixer MX may be deduced from the method steps as previously described in connection with the FIGS. 3 to 6.

Although described with respect to particular embodiments, the idea of this invention may also be used within a point-to-point scenario.

In these use cases are communication is directly point to point between a media sender SRC and a receiver EP1, i.e. there might be no need for forwarding of a media stream. Thus, one may provide a media stream, transport it to the media receiver EP1, where it is consumed as optimal as possible for the application. Thanks to this one-to-one mapping between encoder SRC and decoder EP1, great flexibility is achieved to produce a media stream as tailored to the receiver's needs EP1 as possible, taking into account the constraints that may exist from media sender SRC, transport network and the receiver EP1. In this case the functionalities of a mixer MX described above may also be embodied in the source SRC, i.e. the encoder itself.

Some constraints may be static, but a number of these may be highly dynamical and thus desirable to adapt to during the session. E.g. a Video Resolution in GUI, i.e. in a video communication application, including WebRTC based ones, the window where the media senders media stream is presented may change, for example due to the user modifying the size of the window. It might also be due to other application related actions, like selecting to show a collaborative work space and thus reducing the area used to show the remote video in. In both of these cases it is the receiver side that knows how big the actual screen area is and what the most suitable resolution would be. It thus appears suitable to let the receiver request the media sender to send a media stream conforming to the displayed video size. It may also be a Network Bit-rate Limitations, i.e. if the receiver discovers a network bandwidth limitation, it can choose to meet it by requesting media stream bit-rate limitations. Especially in cases where a media sender provides multiple media streams, the relative distribution of available bit-rate could help the application provide the most suitable experience in a constrained situation. It may also be a CPU Constraint, i.e. a media receiver may become constrained in the amount of available processing resources. This may occur in the middle of a session for example due to the user selecting a power saving mode, or starting additional applications requiring resources. When this occurs, the receiving application can select which codec parameters to constrain and how much constrained they should be to best suit the needs of the application. For example, if lower framerate is somehow a better constraint than lower resolution.

By means of the method and/or the mixer as described above, the invention allows for providing media streams towards different endpoints in an efficient manner. In particular, different endpoints having different capabilities as well as different networks being used for communication may be served in an efficient manner, in particular in a manner which is not negatively impacted by renegotiations due to timing constraints. In particular, the invention allows for reduced network loads as it allows for benefiting from scalability opportunities offered by a growing number of codecs. Furthermore, the Mixer may in a flexible manner adapt the requests from different endpoints such that they on one hand are matched to each other and allow for deviations while allowing for reducing the amount of signaled data as the encoding of the SRC may be chosen appropriately to reduce network load.

The solution presented enables dynamic control of possibly inter-related codec properties during an ongoing media session. It allows for being media type agnostic, to the furthest extent possible, and at least is feasible for audio and video media. It allows for being codec agnostic (within the same media type), to the furthest extent possible. It allows for operation of different media transmission types, i.e. single-stream, simulcast, single-stream scalable, and multi-stream scalable transmission. Also the solution is not impaired by encrypted media. Additionally, the solution presented is extensible and allows for adding control and description of new codec properties. As the solution presented may complement other codec configuration methods such as e.g. other RTCP based techniques and SDP it will not conflict with them. Additionally, the solution presented supports configurable parameters which are directly visible in the media stream as well as those that are not visible in the media stream.

The mechanism in this specification may not replace SDP, or the SDP Offer/Answer mechanism. For example, SDP may be used for negotiating and configuring boundary values for codec properties, while COP, e.g. according to the embodiments of this invention, may be used to communicate specific values within those boundaries, e.g. if there is no impact on the values negotiated using SDP. It may therefore still be possible to establish communication sessions even if one or more endpoints do not support COP.

The invention has been described with no particular reference towards a specific network as there may be different arrangements in which the invention may be embodied. In particular, the invention may be embodied in any fixed or mobile communication network. Additionally, the invention may also be embodied in systems having different means for transporting messages in direction of the mixer towards a decoder, respectively a source towards a mixer (downstream), and means for transporting messages in direction of a decoder towards a mixer, respectively a mixer towards a source (upstream), e.g. while the upstream direction may use a fixed communication network, the downstream direction may use a broadcast system.

Furthermore, even though the invention has been described with respect to a mixer, the invention may also be embodied in other nodes of a network such as proxies, routers or a media source (encoder) or any other suitable network node.

The particular combination of elements and features in the above detailed embodiments are exemplary only; the interchanging and substitution of these embodiments with other embodiments disclosed herein are also expressly contemplated. As those skilled in the art will recognize, variations, modifications, and other implementations of what is described herein can occur to those of ordinary skill in the art without departing from the spirit and the scope of the invention as claimed.

Accordingly, the foregoing description is by way of example only and is not intended as limiting. The invention's scope is defined in the following claims and the equivalents thereto. Furthermore, reference signs used in the description and/or claims do not limit the scope of the invention as claimed.

### ABBREVIATIONS USED WITHIN THE APPLICATION

AVC Advanced Video Coding
AVPF Extended RTP Profile for RTCP-Based Feedback
AOPR Audio Operation Point Request
COP Codec Operation Point
COPA Codec Operation Point Acknowledge
COPR Codec Operation Point Request
COPN Codec Operation Point Notification
CPT Codec Parameter Type
FCI Feedback Control Information
FMT Feedback Message Type
GUI Graphical User Interface
MST Multi-Session Transmission for SVC
MVC Multiview Video Coding
OP Operation Point
OPID Operation Point identification
SPS Sequence Parameter Set
SST Single-Session Transmission for SVC
SVC Scalable Video Coding
VOP Video Operation Point, a special COP
VOPR Video Operation Point Request, a special COPR
VOPA Video Operation Point Acknowledge, a special COPA
VOPN Video Operation Point Notification, a special COPN

1. A method for providing media streams towards a plurality of endpoints, the media streams originating from one or more media source(s), comprising the steps of:
receiving at least a first request set of a first endpoint of said plurality of endpoints and receiving a second request set of a second endpoint of said plurality of endpoints, wherein a request set comprises information relating to at least a subset of one or more codec parameter, and wherein a request set pertains to a media stream, wherein said first request set and said second request set pertain to a same media content;
aggregating said received first request set and said received second request set into an aggregated request set pertaining to a first media source;
requesting a media stream according to said aggregated request set from said first media source;
receiving said requested media stream from said first media source;
delivering a first media stream towards said first endpoint according to the first request set; and
delivering a second media stream towards said second endpoint according to the second request set.

2. The method according to claim 1, wherein said request sets are provided within one or more Codec Operation Point Request messages.

3. The method according to claim 1, wherein in response to a request set an acknowledgement message is sent.

4. The method according to claim 1, wherein the respective aggregated information relating to said first request set is signaled towards said first endpoint within one or more Codec Operation Point Notification message(s).

5. The method according to claim 1, wherein a change of aggregated information relating to said first request set is signaled towards said first endpoint within one or more one Codec Operation Point Notification message(s).

6. The method according to claim 1, wherein the step of aggregating comprises, if the first request set towards a particular media stream and the second request set towards said particular media stream are identical, only one request set towards said particular media stream is provided within the aggregated request set.

7. The method according to claim 1, wherein the step of aggregating comprises, if an information relating to at least a subset of one or more codec parameter(s), within said first request set towards a particular media stream is not present in said information relating to at least a subset of one or more codec parameter(s), within said second request set towards said particular media stream, combining the information of the request sets such that each information is present at least once within the aggregated request set.

8. The method according to claim 1, wherein the step of aggregating comprises, if an information relating to at least a subset of one or more codec parameter(s), within said first request set towards a particular media stream is also present in said information relating to at least a subset of one or more codec parameter(s), within said second request set towards said particular media stream but the information is deviating from one another, if the deviating information is pertaining to a maximum constraint, combining the information of the request sets such that the information pertaining to a lower requirement is present within the aggregated request set, and if the deviating information is pertaining to a minimum constraint, combining the information of the request sets such that the information pertaining to a higher requirement is present within the aggregated request set.

9. The method according to claim 1, wherein the media stream comprises a scalable encoding, and wherein said first media stream comprises only portions of said second media stream.

10. A mixer for providing media streams towards a plurality of endpoints, the media streams originating from one or more media source(s), comprising:
a receiver adapted for receiving at least a first request set of a first endpoint of said plurality of endpoints and a second request set of a second endpoint of said plurality of endpoints, wherein a request set comprises information relating to at least a subset of one or more codec parameter(s), and wherein a request set pertains to a media stream, wherein said first request set and said second request set pertain to a same media content;
a control unit for aggregating said received first request set and said received second request set into an aggregated request set pertaining to a first media source; and
a sender adapted for requesting a media stream according to said aggregated request set from said first media source,
wherein said receiver is further adapted for receiving said requested media stream from said first media source and wherein said sender is further adapted for delivering a first media stream towards said first endpoint according to the first request set and wherein said sender is further adapted for delivering a second media stream towards said second endpoint according to the second request set.

11. The mixer according to claim 10, wherein said request sets are provided within one or more Codec Operation Point Request message(s).

12. The mixer according to claim 10, wherein said sender is further adapted for sending an acknowledgement message in response to a request set.

13. The mixer according to claim 10, wherein said sender is further adapted for signaling the respective aggregated information relating to said first request set towards said first endpoint within one or more Codec Operation Point Notification message(s).

14. The mixer according to claim 10, wherein said sender is further adapted for signaling a change of aggregated information relating to said first request set towards said first endpoint within one or more one Codec Operation Point Notification message(s).

15. The mixer according to claim 10, wherein the control unit is further adapted for determining if the first request set towards a particular media stream and the second request set towards said particular media stream are identical, and if the condition is fulfilled, said control unit is further adapted for instigating the sender to provide only one request set thereof towards said particular media stream within the aggregated request set.

16. The mixer according to claim 10, wherein the control unit is further adapted for determining if an information relating to at least a subset of one or more codec parameter(s), within said first request set towards a particular media stream is not present in said information relating to at least a subset of one or more codec parameter(s) within said second request set towards said particular media stream, and if the condition is fulfilled, said control unit is further adapted for combining the information of the request sets such that each information is present at least once within the aggregated request set.

17. The mixer according to claim 10, wherein the control unit is further adapted for determining if an information relating to at least a subset of one or more codec parameter(s) within said first request set towards a particular media stream is also present in said information relating to at least a subset of one or more codec parameters within said second request set towards said particular media stream but the information is deviating from one another, and if the deviating information is pertaining to a maximum constraint and if the conditions are fulfilled, said control unit is further adapted for combining the information of the request sets such that the information pertaining to a lower requirement is present within the aggregated request set, and, if the deviating information is pertaining to a minimum constraint, and if the conditions are fulfilled, said control unit is further adapted for combining the information of the request sets such that the information pertaining to a higher requirement is present within the aggregated request set.

18. The mixer according to claim 10, wherein the media stream comprises a scalable encoding and wherein said first media stream comprises only portions of said second media stream.
